(19) United States
(12) Patent Application Publication
(10) Pub. No.: US 2008/0177630 A1
(43) Pub. Date: Jul. 24, 2008

(54) Method apparatus, system, media, and signals for billing a sponsor of an object link in interactive sequenced media

(76) Inventors: Babak Maghfourian, Vancouver (CA); Theodore Alexander Curylo, Vancouver (CA)

Correspondence Address: Ralph A. Dowell of DOWELL & DOWELL P.C., 2111 Eisenhower Ave, Suite 406, Alexandria, VA, 22314, US

(21) Appl. No.: 12/010,080

(22) Filed: Jan. 18, 2008

Related U.S. Application Data
(60) Provisional application No. 60/881,187, filed on Jan. 19, 2007.

(51) Int. Cl. G06Q 30/00

(52) U.S. Cl. 705/14

(57) ABSTRACT

A system for displaying interactive sequenced media is disclosed. The system includes a client display apparatus and a billing server, the client display apparatus and the billing server being in communication with a computer network. The client display apparatus includes a processor circuit operably configured to cause at least one dynamic object in the interactive sequenced media to be displayed, the dynamic object having an associated object link that follows said dynamic object. The client display apparatus processor circuit is also operably configured to cause a billing message to be transmitted over the computer network to the billing server in response to a user of the client display apparatus selecting the object link. The billing message includes a dynamic object identifier identifying the dynamic object. The billing server includes a processor circuit. The processor circuit is operably configured to receive the billing message from the client display apparatus and to associate a billing entry with a sponsor account associated with the dynamic object identifier to make a charge to the sponsor account as a result of the user selecting the object link.

### RELATED APPLICATIONS

This application claims the benefit of provisional patent application 60/881,187 entitled “METHOD, APPARATUS, SYSTEM, MEDIA, AND SIGNALS FOR BILLING A SPONSOR OF AN OBJECT LINK IN INTERACTIVE SEQUENCED MEDIA”, filed on Jan. 19, 2007 and incorporated herein by reference in its entirety.

### BACKGROUND OF THE INVENTION

1. Field of Invention

This invention relates generally to interactive sequenced media, and more particularly to producing billing entries in response to user selection of an object link associated with a dynamic object.

2. Description of Related Art

Links in HTML documents displayed in web browser applications have been used to lead users to web sites and/or to associated advertising when the link is clicked. Advertisers who sponsor such links may be billed each time the advertisement is viewed, or each time a user clicks on the advertisement to obtain further information.

Web pages including hyperlinks are by nature static, and consequently the link architecture is also static. High speed connections to the internet are becoming increasingly common, and there is a corresponding increase in video and animated content being downloaded and viewed on internet connected computers. Such content may be viewed in QuickTime® or Adobe Flash® media players for example, which have a large installed base and are generally provided free of charge by the respective software owners.

The use of interactive links in video content has not yet seen the same level of usage as static links in static web pages. Accordingly, there remains a need for improved methods and apparatus for generating and processing links to dynamic objects in video and animated content.

### SUMMARY OF THE INVENTION

In accordance with one aspect of the invention there is provided a method of displaying interactive sequenced media on a client display apparatus. The method involves causing at least one dynamic object in the interactive sequenced media to be displayed on the client display apparatus, the dynamic object having an associated object link that follows the dynamic object, and causing a billing message to be transmitted over a computer network to a billing server in response to a user of the client display apparatus selecting the object link.

The method may involve receiving the interactive sequenced media over the computer network from a media server.

Causing the at least one dynamic object to be displayed may involve displaying a first track in the interactive sequenced media, the first media track may include data defining the dynamic object.

The method may involve displaying a second media track having at least one invisible shape and may further involve modifying a position of the invisible shape to cause the invisible shape to follow to the dynamic object, the invisible shape defining a display area on the client display apparatus configured to activate the object link when selected by the user.

The method may involve modifying at least one of a size and a geometrical distortion of the invisible shape to cause the shape to generally correspond to the dynamic object.

The method may involve displaying an animation in a display area of the client display apparatus in response to selecting.

The method may involve generating a request for content associated with the object link in response to selecting.

The method may involve displaying the content on the client display apparatus.

The interactive sequenced media may be displayed in a first portion of a display area of the client display apparatus and displaying the content may involve displaying the content in a second portion of the display area of the client display apparatus.

Causing the billing message to be transmitted in response to selecting may involve causing the billing message to be transmitted in response to at least one of the user causing a pointer displayed in a display area of the client display apparatus to move over the object link, and the user actuating an actuator on the client display apparatus while the pointer is over the object link.

The method may involve causing a text message to be displayed over the interactive sequenced media in response to the user causing the pointer to move over the object link.

The method may involve stopping display of the interactive sequenced media in response to selecting.

Transmitting the billing message may involve transmitting a network location of the billing server on the network, information identifying the dynamic object that was selected by the user of the client display apparatus.

Transmitting the information identifying the dynamic object may involve transmitting at least one of an object identifier, a time duration for which the dynamic object was displayed, a number of display pixels occupied by the dynamic object when displayed, and information identifying an additional action performed in response to selecting.

Transmitting the billing message may further involve transmitting display condition information associated with displaying the interactive sequenced media on the client display apparatus.

Transmitting the display condition information may involve transmitting at least one of a serial number associated with the interactive sequenced media, a name associated with the interactive sequenced media, a length of the interactive sequenced media, a number of frames per second associated with the interactive sequenced media, a display area size of a media viewer used on the client display apparatus to display the interactive sequenced media, a video compression/decompression algorithm (codec) associated with the interactive sequenced media, and an audio compression/decompression algorithm (codec) associated with audio content in the interactive sequenced media, and a category associated with the interactive sequenced media, and information indicating that the user has viewed a first portion of the interactive sequenced media.

Transmitting the billing message may further involve transmitting a location and a name of a script stored on the billing server, the script being operable to read and interpret the billing message.

In accordance with another aspect of the invention there is provided a computer readable medium encoded with instructions for directing a processor circuit to display interactive sequenced media on a client display apparatus, the instructions. The computer readable medium includes instructions for directing the processor circuit to cause at least one dynamic object in the interactive sequenced media to be displayed on the client display apparatus, the dynamic object having an associated object link that follows the dynamic object, and cause a billing message to be transmitted over a computer network to a billing server in response to a user of the client display apparatus selecting the object link.

In accordance with another aspect of the invention there is provided a client display apparatus for displaying interactive sequenced media. The apparatus includes provisions for causing at least one dynamic object in the interactive sequenced media to be displayed, the dynamic object having an associated object link that follows the dynamic object. The apparatus also includes provisions for causing a billing message to be transmitted over a computer network to a billing server in response to selecting.

The provisions for transmitting the billing message may include provisions for transmitting a network location of the billing server on the network, information identifying the dynamic object that was selected by the user of the client display apparatus.

The provisions for transmitting the information identifying the dynamic object may include provisions for transmitting at least one of an object identifier, a time duration for which the dynamic object was displayed, a number of display pixels occupied by the dynamic object when displayed, and information identifying an additional action performed in response to selecting.

The provisions for transmitting the billing message may further include provisions for transmitting display condition information associated with displaying the interactive sequenced media on the client display apparatus.

The provisions for transmitting the display condition information may include provisions for transmitting at least one of a serial number associated with the interactive sequenced media, a name associated with the interactive sequenced media, a length of the interactive sequenced media, a number of frames per second associated with the interactive sequenced media, a display area size of a media viewer used on the client display apparatus to display the interactive sequenced media, a video compression/decompression algorithm (codec) associated with the interactive sequenced media, and an audio compression/decompression algorithm (codec) associated with audio content in the interactive sequenced media, and a category associated with the interactive sequenced media, and information indicating that the user has viewed a first portion of the interactive sequenced media.

The provisions for transmitting the billing message may further include provisions for transmitting a location and a name of a script stored on the billing server, the script being operable to read and interpret the billing message.

In accordance with another aspect of the invention there is provided a client display apparatus for displaying interactive sequenced media. The apparatus includes a processor circuit operably configured to cause at least one dynamic object in the interactive sequenced media to be displayed, the dynamic object having an associated object link that follows the dynamic object. The processor circuit is also operably configured to cause a billing message to be transmitted over a computer network to a billing server in response to selecting.

The apparatus may include an interface for receiving the interactive sequenced media over the computer network from a media server.

The processor circuit may be operably configured to display a first track in the interactive sequenced media, the first media track may include data defining the dynamic object.

The processor circuit may be operably configured to display a second media track having at least one invisible shape and the processor circuit may be further operably configured to modify a position of the invisible shape to cause the invisible shape to follow to the dynamic object, the invisible shape defining a display area on the client display apparatus configured to activate the object link when selected by the user.

The processor circuit may be operably configured to modify at least one of a size and a geometrical distortion of the invisible shape to cause the shape to generally correspond to the dynamic object.

The processor circuit may be operably configured to display an animation in a display area of the client display apparatus in response to selecting.

The processor circuit may be operably configured to generate a request for content associated with the object link in response to selecting.

The processor circuit may be operably configured to display the content on the client display apparatus.

The processor circuit may be operably configured to display the interactive sequenced media in a first portion of a display area of the client display apparatus and the provisions for displaying the content may include provisions for displaying the content in a second portion of the display area of the client display apparatus.

The processor circuit may be operably configured to cause the billing message to be transmitted in response to at least one of the user causing a pointer displayed in a display area of the client display apparatus to move over the object link, and the user actuating an actuator on the client display apparatus while the pointer may be over the object link.

The processor circuit may be operably configured to cause a text message to be displayed over the interactive sequenced media in response to the user causing the pointer to move over the object link.

The processor circuit may be operably configured to stop display of the interactive sequenced media in response to selecting.

The billing message may include a network location of the billing server on the network, information identifying the dynamic object that was selected by the user of the client display apparatus.

The information identifying the dynamic object may include at least one of an object identifier, a time duration for which the dynamic object was displayed, a number of display pixels occupied by the dynamic object when displayed, and information identifying an additional action performed in response to selecting.

The processor circuit may be operably configured to transmit display condition information associated with displaying the interactive sequenced media on the client display apparatus.

The display condition information may include at least one of a serial number associated with the interactive sequenced media, a name associated with the interactive sequenced media, a length of the interactive sequenced media, a number of frames per second associated with the interactive sequenced media, a display area size of a media viewer used on the client display apparatus to display the interactive sequenced media, a video compression/decompression algorithm (codec) associated with the interactive sequenced media, and an audio compression/decompression algorithm (codec) associated with audio content in the interactive sequenced media, and a category associated with the interactive sequenced media, and information indicating that the user has viewed a first portion of the interactive sequenced media.

The billing message may further include a location and a name of a script stored on the billing server, the script being operable to read and interpret the billing message.

In accordance with another aspect of the invention there is provided a method for billing a sponsor of a dynamic object. The method involves receiving a billing message at a billing server, the billing message representing user selection of an object link that follows the dynamic object displayed in interactive sequenced media on a client display apparatus, the billing message including a dynamic object identifier identifying the dynamic object. The method also involves and associating a billing entry with a sponsor account associated with the dynamic object identifier to make a charge to the sponsor account as a result of the user selecting the object link.

Receiving the billing message may further involve receiving at least one of a time duration for which the dynamic object was displayed, a number of display pixels occupied by the dynamic object when displayed, and information identifying an additional action performed in response to selecting.

Receiving the billing message may further involve receiving display condition information associated with displaying the interactive sequenced media on the client display apparatus.

Receiving the display condition information may involve receiving at least one of a serial number associated with the interactive sequenced media, a name associated with the interactive sequenced media, a length of the interactive sequenced media, a number of frames per second associated with the interactive sequenced media, a display area size of a media viewer used on the client display apparatus to display the interactive sequenced media, a video compression/decompression algorithm (codec) associated with the interactive sequenced media, and an audio compression/decompression algorithm (codec) associated with audio content in the interactive sequenced media, and a category associated with the interactive sequenced media, and information indicating that the user has viewed a first portion of the interactive sequenced media.

Receiving the billing message may further involve receiving a location and a name of a script stored on the billing server, the script being operable to read and interpret the billing message.

The method may involve storing the dynamic object identifier in a billing entry table in a database.

Associating the billing entry with a sponsor account may involve reading the dynamic object identifier stored in the billing entry table and locating a sponsor record having a corresponding dynamic object identifier, the sponsor record being stored in a sponsor table in the database.

Locating may further involve reading a sponsor name field in the sponsor record and causing a charge entry to be added to a sponsor account table stored in the database.

Causing the charge entry to be added may involve causing a charge entry to be added to the sponsor account table, the charge entry including display condition information associated with displaying the interactive sequenced media on the client display apparatus.

The method may involve reading the sponsor account table and causing a bill to be produced for sending to the sponsor.

In accordance with another aspect of the invention there is provided a computer readable medium encoded with codes for directing a processor circuit to bill a sponsor of a dynamic object. The codes direct the processor circuit to receive a billing message at a billing server, the billing message representing user selection of an object link that follows the dynamic object displayed in interactive sequenced media on a client display apparatus, the billing message including a dynamic object identifier identifying the dynamic object. The codes also direct the processor circuit to associate a billing entry with a sponsor account associated with the dynamic object identifier to make a charge to the sponsor account as a result of the user selecting the object link.

In accordance with another aspect of the invention there is provided a billing server apparatus for billing a sponsor of a dynamic object. The apparatus includes provisions for receiving a billing message at a billing server, the billing message representing user selection of an object link that follows the dynamic object displayed in interactive sequenced media on a client display apparatus, the billing message including a dynamic object identifier identifying the dynamic object. The apparatus also includes provisions for associating a billing entry with a sponsor account associated with the dynamic object identifier to make a charge to the sponsor account as a result of the user selecting the object link.

The provisions for receiving the billing message may further include provisions for receiving at least one of a time duration for which the dynamic object was displayed, a number of display pixels occupied by the dynamic object when displayed, and information identifying an additional action performed in response to selecting.

The provisions for receiving the billing message may further include provisions for receiving display condition information associated with displaying the interactive sequenced media on the client display apparatus.

The provisions for receiving the display condition information may include provisions for receiving at least one of a serial number associated with the interactive sequenced media, a name associated with the interactive sequenced media, a length of the interactive sequenced media, a number of frames per second associated with the interactive sequenced media, a display area size of a media viewer used on the client display apparatus to display the interactive sequenced media, a video compression/decompression algorithm (codec) associated with the interactive sequenced media, and an audio compression/decompression algorithm (codec) associated with audio content in the interactive sequenced media, and a category associated with the interactive sequenced media, and information indicating that the user has viewed a first portion of the interactive sequenced media.

The provisions for receiving the billing message may further include provisions for receiving a location and a name of a script stored on the billing server, the script being operable to read and interpret the billing message.

The apparatus may include provisions for storing the dynamic object identifier in a billing entry table in a database.

The provisions for associating the billing entry with a sponsor account may include provisions for reading the dynamic object identifier stored in the billing entry table and provisions for locating a sponsor record having a corresponding dynamic object identifier, the sponsor record being stored in a sponsor table in the database.

The provisions for locating may further include provisions for reading a sponsor name field in the sponsor record and provisions for causing a charge entry to be added to a sponsor account table stored in the database.

The provisions for causing the charge entry to be added may include provisions for causing a charge entry to be added to the sponsor account table, the charge entry including display condition information associated with displaying the interactive sequenced media on the client display apparatus.

The apparatus may include provisions for reading the sponsor account table and causing a bill to be produced for sending to the sponsor.

In accordance with another aspect of the invention there is provided a billing server apparatus for billing a sponsor of a dynamic object in interactive sequenced media. The apparatus includes a processor circuit operably configured to receive a billing message at a billing server, the billing message representing user selection of an object link that follows the dynamic object displayed in interactive sequenced media on a client display apparatus, the billing message including a dynamic object identifier identifying the dynamic object. The processor circuit is also operably configured to associate a billing entry with a sponsor account associated with the dynamic object identifier to make a charge to the sponsor account as a result of the user selecting the object link.

The billing message may include at least one of a time duration for which the dynamic object was displayed, a number of display pixels occupied by the dynamic object when displayed, and information identifying an additional action performed in response to selecting.

The billing message may further include display condition information associated with displaying the interactive sequenced media on the client display apparatus.

The display condition information may include at least one of a serial number associated with the interactive sequenced media, a name associated with the interactive sequenced media, a length of the interactive sequenced media, a number of frames per second associated with the interactive sequenced media, a display area size of a media viewer used on the client display apparatus to display the interactive sequenced media, a video compression/decompression algorithm (codec) associated with the interactive sequenced media, and an audio compression/decompression algorithm (codec) associated with audio content in the interactive sequenced media, and a category associated with the interactive sequenced media, and information indicating that the user has viewed a first portion of the interactive sequenced media.

The billing message may further include a location and a name of a script stored on the billing server apparatus, the script being operable to read and interpret the billing message.

The processor circuit may be operably configured to provide database functions and the processor circuit may be operably configured to store the dynamic object identifier in a billing entry table in the database.

The processor circuit may be operably configured to read the dynamic object identifier stored in the billing entry table to locate a sponsor record having a corresponding dynamic object identifier, the sponsor record being stored in a sponsor table in the database.

The processor circuit may be operably configured to read a sponsor name field in the sponsor record and to cause a charge entry to be added to a sponsor account table stored in the database.

The processor circuit may be operably configured to cause a charge entry to be added to the sponsor account table, the charge entry including display condition information associated with displaying the interactive sequenced media on the client display apparatus.

The processor circuit may be operably configured to read the sponsor account table and to cause a bill to be produced for sending to the sponsor.

In accordance with another aspect of the invention there is provided a system for displaying interactive sequenced media. The system includes a client display apparatus, and a billing server, the client display apparatus and the billing server being in communication with a computer network. The client display apparatus includes a processor circuit operably configured to cause at least one dynamic object in the interactive sequenced media to be displayed, the dynamic object having an associated object link that follows the dynamic object, and to cause a billing message to be transmitted over the computer network to the billing server in response to a user of the client display apparatus selecting the object link. The billing message includes a dynamic object identifier identifying the dynamic object. The billing server includes a processor circuit, the processor circuit being operably configured to receive the billing message from the client display apparatus and associate a billing entry with a sponsor account associated with the dynamic object identifier to make a charge to the sponsor account as a result of the user selecting the object link.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic view of a system for billing a sponsor of a dynamic object in accordance with a first embodiment of the invention;

FIG. 2 is a screenshot of a media player displayed on a client display apparatus used in the system shown in FIG. 1;

FIG. 3 is a schematic view of a processor circuit for implementing a media server shown in FIG. 1;

FIG. 4 is a screenshot of a web page produced by the media server processor circuit shown in FIG. 3;

FIG. 5 is a flowchart including blocks of codes for directing the processor circuit shown in FIG. 3 to transmit sequenced media data;

FIG. 6 is a schematic view of a processor circuit for implementing a client display apparatus shown in FIG. 1;

FIG. 7 is a schematic view of an interactive sequenced media file transmitted by the processor circuit shown in FIG. 1, and received by the processor circuit shown in FIG. 6;

FIG. 8 is a table of track data variables used in an object links track in the sequenced media file shown in FIG. 7;

FIG. 9 is a table of sprite data variables used in an object links track in the sequenced media file shown in FIG. 7;

FIG. 10 is a flowchart including blocks of codes for directing the processor circuit shown in FIG. 6 to receive interactive sequenced media data;

FIG. 11 is a flowchart including blocks of codes for directing the processor circuit shown in FIG. 6 to respond to a rollover of an object link in the interactive sequenced media;

FIG. 12 is a flowchart including blocks of codes for directing the processor circuit shown in FIG. 6 to respond to the object link in the interactive sequenced media being clicked;

FIG. 13 is a schematic view of an exemplary billing message produced by the processor circuit shown in FIG. 6;

FIG. 14 is a flowchart including blocks of codes for directing the processor circuit shown in FIG. 6 to further process rollover or clicking of the object link in the interactive sequenced media being clicked;

FIG. 15 is a schematic view of a processor circuit for implementing a billing server shown in FIG. 1;

FIG. 16 is a flowchart including blocks of codes for directing the processor circuit shown in FIG. 15 to receive the billing message shown in FIG. 13;

FIG. 17 is a schematic representation of a billing entry table produced by the processor circuit shown in FIG. 15;

FIG. 18 is a schematic representation of a sponsor table produced by the processor circuit shown in FIG. 15;

FIG. 19 is a flowchart including blocks of codes for directing the processor circuit shown in FIG. 15 to initiate billing of sponsors; and

FIG. 20 is a schematic representation of a sponsor account table produced by the processor circuit shown in FIG. 15.

### DETAILED DESCRIPTION

### System Overview

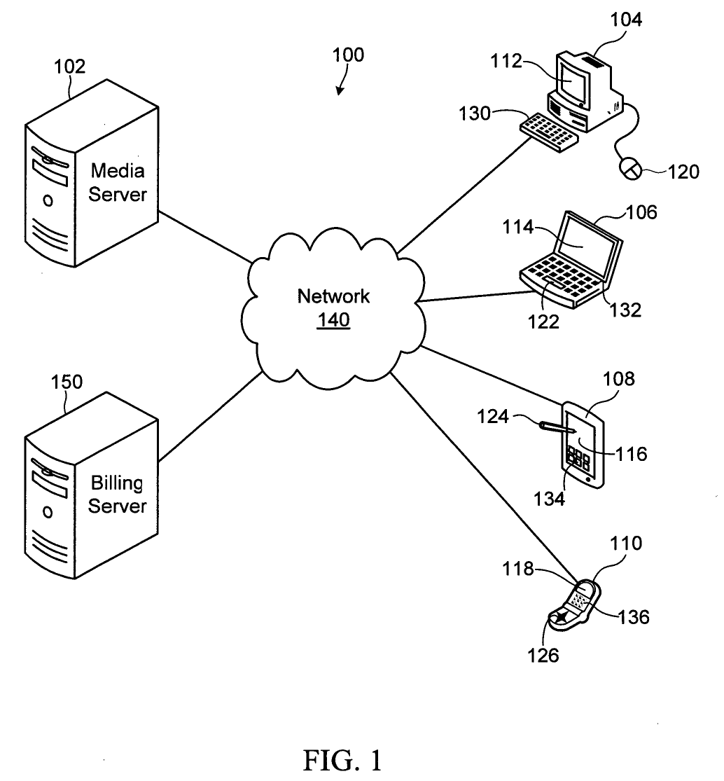

Referring to FIG. 1, a system for transmitting interactive sequenced media is shown generally at 100. The system 100 includes a media server 102 and a plurality of client display apparatuses 104, 106, 108, and 110. In this embodiment, the client display apparatus 104 is a conventional desktop computer, the client display apparatus 106 is a laptop computer, the client display apparatus 108 is a handheld tablet computer, and the client display apparatus 110 is a cellular telephone. Each of the client display apparatuses 104, 106, 108, and 110 has a respective display 112, 114, 116, and 118 for displaying the sequenced media.

Each of the client display apparatuses 104, 106, 108, and 110 also has a pointing device 120, 122, 124, and 126. In this embodiment the pointing device 120 is a conventional handheld pointing device such as a computer mouse, the pointing device 122 is a touch pad, the pointing device 124 is a stylus for drawing on a touch sensitive display 116, and the pointing device 126 is a pointer actuator button. The pointing devices 120, 122, 124, and 126 generally cause a pointer displayed on a display area of the respective displays 112, 114, 116, and 118 to move in response to user actuation of the pointing device (for example moving the mouse 120).

Each of the client display apparatuses 104, 106, 108, and 110 may further include a user input device 130, 132, 134, and 136. The user input devices 130 and 132 are both conventional keyboard input devices. The user input device 134 may include areas on a touch sensitive display 116, which are configured to produce some action when selected by the stylus pointing device 124. The user input device 136 includes a plurality of buttons, such as a keypad, for interacting with the apparatus.

In general, the pointing devices 120, 122, 124, and 126, and the user input devices 130, 132, 134, and 136 provide functions for facilitating user interaction with the displayed media on the client display apparatuses 104, 106, 108, and 110.

Each of the client display apparatuses 104, 106, 108, and 110 communicate with the media server 102 over a network 140, such as the internet or an intranet, for example. Communication between the respective client display apparatuses 104, 106, 108, and 110 and the network 140 may be through wired or wireless communication links, for example.

The system 100 further includes a billing server 150 which is in communication with the client display apparatuses 104, 106, 108, and 110 over the network 140.

In general, the media server 102 delivers interactive sequenced media to the client display apparatuses 104, 106, 108, and 110 over the network 140. The media server 102 may include a hyper text transfer protocol (HTTP) server, a real time streaming protocol (RTSP) server, or any other server that is configured to deliver and/or stream media over the network 140 to the client display apparatuses 104, 106, 108, and 110.

The interactive sequenced media may be in a format such as Apple QuickTime, or Adobe Flash, for example. The sequenced media may include a plurality of sequential still images representing one or more dynamic objects, which are displayed to the user in sequence, such that the dynamic objects change position and/or shape on the client display apparatuses. The dynamic objects in the sequenced media may include animated objects, representations of real objects, or a combination of a still image background and real and/or animated foreground objects. Interactive sequenced media having object links associated with dynamic objects in the media is sometimes referred to as “hypervideo” or “hyperlinked video”.

The client display apparatuses 104, 106, 108, and 110 each provide functions for displaying the sequenced media on the respective displays 112, 114, 116, and 118. For example, the client display apparatuses 104, 106, 108, and 110 may be configured to run a media player such as QuickTime Player, or to run a web browser having Flash Player plug-in configured to display sequenced media content. The media player facilitates display of the interactive sequenced media on the client display apparatuses 104, 106, 108, and 110 and further facilitates user interaction with the interactive sequenced media.

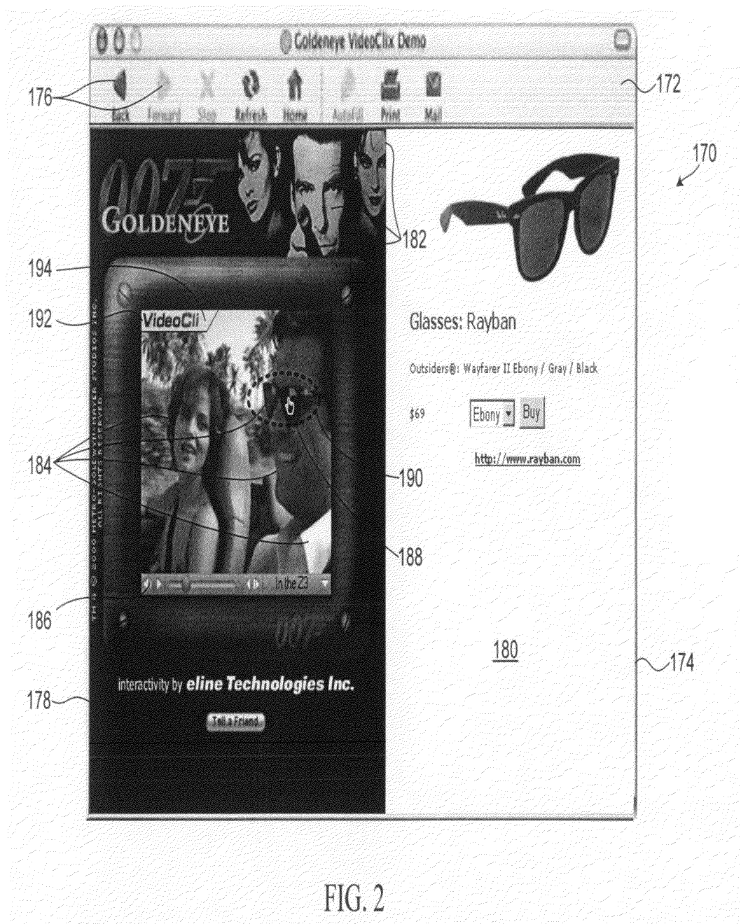

Referring to FIG. 2, a screenshot of a QuickTime media player, as displayed on any one of the client display apparatuses 104, 106, 108, 110, is shown generally at 170. The media player 170 includes a player control panel 172, and a media display area 174. The control panel 172 includes a plurality of control buttons 176 for controlling the playback of sequenced media files in the display area 174. The display area 174 further includes a first frame 178 for displaying the sequenced media, and a second frame 180 for displaying static content.

The first frame 178 includes optional static objects 182, and a plurality of dynamic objects 184. The static objects 182 may provide a background for the viewing of the dynamic objects 184, for example. The first frame 178 may also include interactive regions 186, which may further provide the user with control over the playback of the sequenced media, as an alternative to using the control buttons 176 in the control panel 172.

In the embodiment shown the dynamic objects 184 include two actors, a vehicle in which the actors are being transported, and the actors' clothing and accessories. The data representing the sequenced media further includes an object link associated with at least one of the dynamic objects 184 displayed on the client display apparatus 104, 106, 108, and/or 110. In the embodiment shown the male actor's sunglasses have an associated object link 190 (shown in broken outline). In this embodiment, the object link 190 is not normally visible to a user of one of the client display devices 104, 106, 108, or 110. In some embodiments the object link 190 may be selectively visible, to enable debugging of the interactive sequenced media and/or to permit users of the client display devices 104, 106, 108, or 110 to view the object link.

The pointing devices 120, 122, 124, and 126 of the client display apparatuses 104, 106, 108, and 110 respectively function to cause a pointer 188 (in this case a hand icon) to move in the first frame 178. In some embodiments, when the user moves the pointer 188 over the object link 190 (for example by moving the pointing device 120) the media player 170 displays text associated with the object link. Such text, which is displayed in response to rolling a mouse over the object link 190 without clicking, is commonly referred to as “rollover” text and the event, which triggers display of rollover text is known as a “rollover event”.

In this embodiment, when the user moves the pointer 188 over the object link 190 and then clicks in the object link, a billing message is transmitted over the computer network 140 to the billing server 150.

The object link 190 may further trigger additional actions in response to the user clicking the object link. For example, the additional actions may include causing a click cue animation 192 to be displayed in the first frame 178. In the embodiment shown, the click cue animation spells out the word “VideoClix”, one letter at a time (in FIG. 2, the letter “x” at 194 has not yet been animated). Alternatively, or additionally the additional actions may include generating a request for content associated with the object link. For example, clicking on the object link 190 may cause content including information about the sunglasses to be displayed in the second frame 180.

Interactive sequenced media including object links associated with dynamic objects 184 may be produced using interactive video authoring software, such as VideoClix™, supplied by VideoClix Technologies Inc. of British Columbia, Canada. The VideoClix software enables production of object links (such as the object link 190), which are associated with and move together with a dynamic object 184 in sequenced media. The use of the VideoClix software to produce interactive sequenced media is described in more detail in the VideoClix user manual version 2.x, released in April 2005, which is incorporated herein by reference.

### Media Server

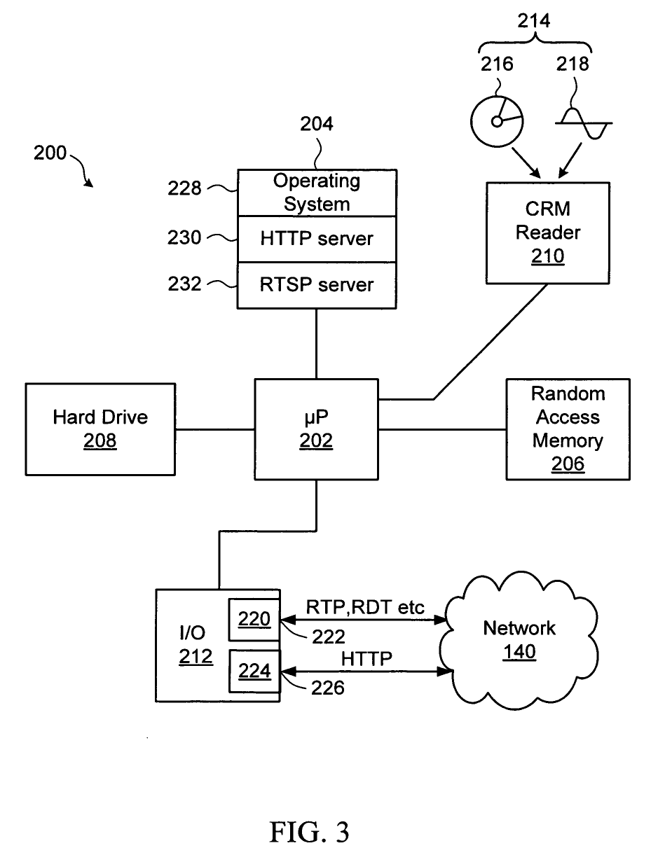

Referring to FIG. 3, in one embodiment the media server 102 may be implemented using a processor circuit shown generally at 200. The processor circuit 200 includes a microprocessor 202, a program memory 204, a random access memory (RAM) 206, a hard drive 208, a computer readable medium (CRM) reader 210, and an input output port (I/O) 212, all of which are in communication with the microprocessor 202.

The CRM reader 210 facilitates loading program codes into the program memory 204 from a computer readable medium 214, such as a CD ROM disk 216, or a computer readable signal 218, such as may be received over a network such as the internet, for example. The CRM reader further facilitates loading interactive sequenced media files into the RAM 206.

Program codes for directing the microprocessor 202 to carry out various functions are stored in the program memory 204, which may be implemented as a random access memory (RAM), and/or a hard disk drive (HDD), or a combination thereof. In this embodiment the program memory 204 includes a first store 228 for storing program codes for directing the microprocessor 202 to provide various operating system functions, a second store 230 for storing program codes for directing the microprocessor 202 to implement a hyper text transfer protocol (HTTP) server, and a third store 232 for storing program codes for directing the microprocessor 202 to implement a real time streaming protocol (RTSP) server.

The hard drive 208 may include a redundant array of independent disks (RAID), which offers increased performance and fault tolerance over conventional single hard drives. In general the hard drive 208 provides bulk storage for storing interactive sequenced media files, and may also provide other storage for operating system and server data.

The I/O 212 includes a first interface 220 having an input/output 222 for receiving and sending data to and from the client display apparatuses 104, 106, 108, and 110 over the network 140. The first interface 220 may include a Gigabit Ethernet interface for streaming the interactive sequenced media files to client display apparatuses 104, 106, 108, and 110.

The I/O 212 includes a second interface 224 having an input/output 226 for receiving and sending data to and from the client display apparatuses 104, 106, 108, and 110 over the network 140. The second interface 224 may also include a Gigabit Ethernet interface for communicating with the client display apparatuses 104, 106, 108, and 110 over the network 140 and for downloading interactive sequenced media files to client display apparatuses.

When a user of one of the client display apparatuses 104, 106, 108, or 110 connects to the media server 102, for example by sending a HTTP request to the second interface 224 of the processor circuit 200, then the HTTP server program codes 230 direct the microprocessor 202 to read data representing a requested web page from the hard drive 208 and to transmit the data to the client display apparatus. In some embodiments, the media server 102 may include a plurality of different web pages stored on the hard drive 208, each web page having links to sequenced media files stored on the hard drive. An example of such a web site is the Google™ Video Beta web page, which includes searchable links to a plurality of available video files.

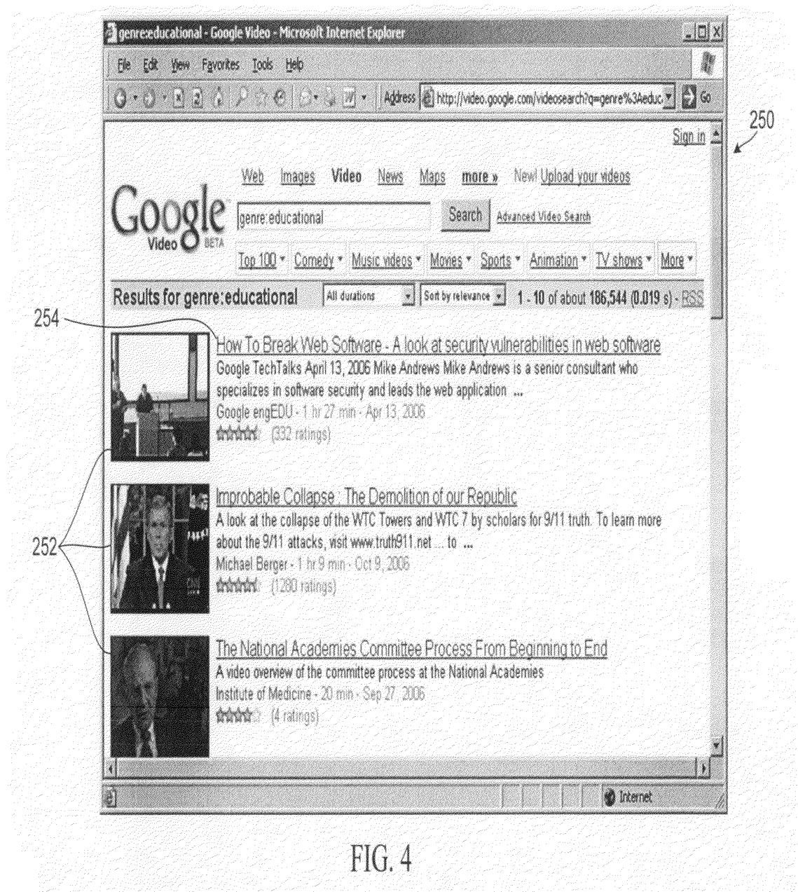

Referring to FIG. 4, a screenshot of an exemplary web page is shown at 250. The web page 250 includes a plurality of thumbnail links 252 and/or a plurality of text links 254 associated with various sequenced media files stored on the hard drive 208.

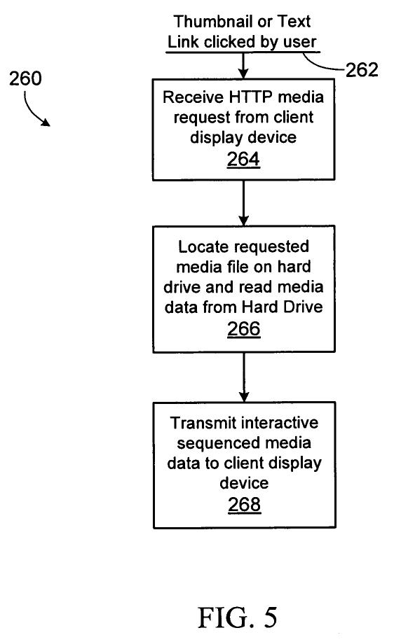

Referring to FIG. 5, a flowchart of blocks of code for directing the processor circuit 200 (shown in FIG. 3) to transmit interactive sequenced media to one of the client display apparatuses 104, 106, 108, or 110 is shown generally at 260. The blocks generally represent codes that may be read from the computer readable medium 214, and stored in the program memory 204, for directing the microprocessor 202 to perform various functions related to transmitting media data. The actual code to implement each block may be written in any suitable program language, such as Flash, Java, C, and/or C++, for example.

The process begins at 262, when the user of one of the client display apparatuses 104, 106, 108, or 110 clicks on one of the thumbnail or text links 252 or 254 (shown in FIG. 4). The process then continues at block 264, which directs the microprocessor 202 to cause the I/O 212 to receive HTTP request data from the client display apparatus. The HTTP request data includes information identifying a sequenced media file stored on the hard drive 208 that the user wishes to display on the client display apparatus.

Block 266 then directs the microprocessor 202 to locate the corresponding sequenced media file on the hard drive 208 and begin reading media data from the hard drive 208. Block 268 then directs the microprocessor 202 to begin transmitting the media data to the client display apparatus 104, 106, 108 or 110.

In one embodiment the web page 250 (shown in FIG. 4) includes Hypertext Markup Language (HTML) codes defining the content, appearance and functionality of the web page, and the HTML codes are transmitted between the media server 102 and the client in accordance with the HTTP protocol.

The sequenced media data may be transmitted from the first interface 220 (shown in FIG. 3) in accordance with a real time streaming protocol, such as Real-time transport protocol (RTP), or Real Data Transport (RDT). Protocols such as RTP and RDT are well suited for transferring media data to be played in real-time or near real-time.

In other embodiments where the media data is downloaded (either partially or in its entirety) before playing, the media data may be transferred using HTTP, or file transfer protocol (FTP), for example.

### Client Display Apparatus

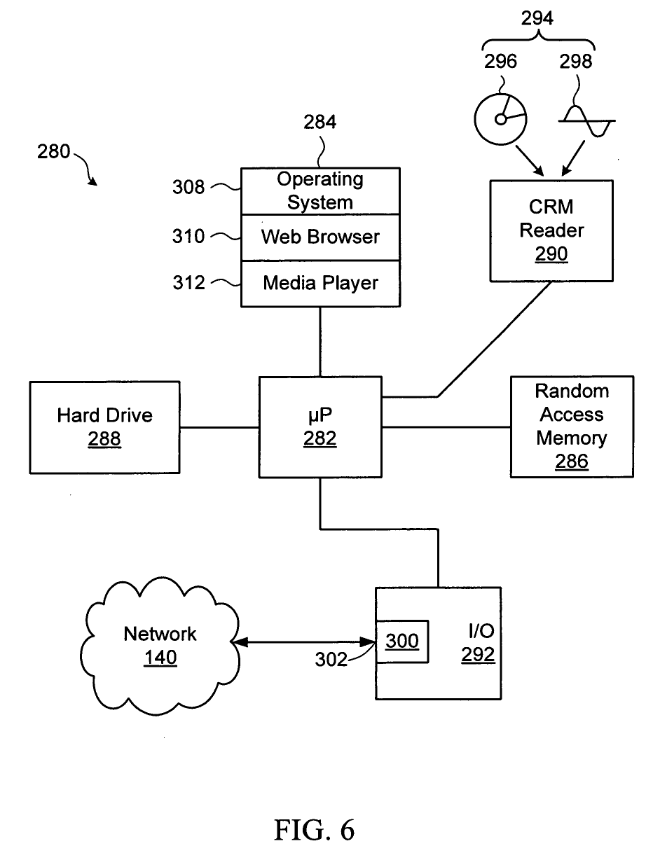

Referring to FIG. 6, an exemplary processor circuit for implementing the client display apparatuses 104, 106, 108, or 110 is shown generally at 280. The processor circuit 280 includes a microprocessor 282, a program memory 284, a random access memory (RAM) 286, a hard drive 288, a computer readable medium (CRM) reader 290, and an input output port (I/O) 292, all of which are in communication with the microprocessor 282.

The CRM reader 290 facilitates loading program codes into the program memory 284 from a computer readable medium 294, such as a CD ROM disk 296, or a computer readable signal 298, such as may be received over a network such as the internet, for example.

Program codes for directing the microprocessor 282 to carry out various functions are stored in the program memory 284, which may be implemented as a random access memory (RAM), and/or a hard disk drive (HDD), or a combination thereof. In this embodiment the program memory 284 includes a first store 308 for storing program codes for directing the microprocessor 282 to provide various operating system functions, a second store 310 for storing program codes for directing the microprocessor 282 to launch a web browser application for viewing Hypertext Markup Language (HTML) pages, and a third store 312 for storing program codes for directing the microprocessor 282 to implement a media player for displaying interactive sequenced media files on the display 112, 114, 116, and 118 of the respective the client display apparatuses 104, 106, 108, and 110.

The RAM 286 and the hard drive 288 provide storage for downloaded sequenced media files, and/or for buffering media data when playing sequenced media files in near real-time.

The I/O 292 includes an interface 300 having an input/output 302 for receiving and sending data to and from the media server 102, and the billing server 150 over the network 140. The interface 300 may include an Ethernet interface, for example, and the communication link between the interface 300 and the network 140 may be a wired or a wireless communications link.

The program codes 310 direct the microprocessor 282 to launch a web browser application for displaying HTML pages, such as the web page 250 shown in FIG. 4. When the user clicks on one of the thumbnail or text links 252 or 254 shown in FIG. 4, the program codes 310 further direct the microprocessor 282 to cause the I/O 292 to transmit a message requesting the sequenced media file associated with the link 252 or 254 to the second interface 224 of the media server processor circuit 200 (shown in FIG. 3). As described above, the media server 102 responds to the request by sending the requested interactive sequenced media file to the client display apparatus.

### Interactive Sequenced Media File Format

Media file formats that support interactive elements include QuickTime and Adobe Flash, for example. In general a variety of software tools are available for producing QuickTime and Flash files from video or animated sequenced media. QuickTime and Flash file formats generally include a plurality of tracks for storing particular types of data, such as audio, video, effects, or text, for example. Both formats also provide functionality to embed interactive elements in the media that perform certain timed actions, such as jumping to different time points in the media file, displaying text captions over the video or animated media, and/or accessing other content such as HTML pages, for example.

### QuickTime File Format

QuickTime movie (.mov) files function as a container for a plurality of tracks. The tracks may include media data or a data reference to media data stored elsewhere on the network. QuickTime .mov files may be streamed to users for viewing in real-time (i.e. the sequenced media may be viewed while being downloaded) or may be downloaded to a memory in the client display apparatus and played at a later time. Alternatively, a portion of the media may be downloaded to a memory to provide sufficient buffer to compensate for network delays that may occur during transmission of the media data over the network 140.

Since the QuickTime media file may include data references to media data stored in different network locations, such data references need to be resolved before displaying the sequenced media. In some embodiments, it may be desirable to provide a single file including all media data for downloading over the network. Such a sequenced media file, which has resolved all references to media data stored in other network locations, is known as a flattened file. Flattened files may be played on any client display apparatus without requiring any additional media data from other locations. While computers running Apple Macintosh operating systems may be able to resolve such data references for QuickTime .mov files, computers running Microsoft Windows® operating system generally require flattened QuickTime files for displaying sequenced media content in a QuickTime media player window.

QuickTime files generally include a plurality of track layers (having indexes ranging from −32768 to 32768). QuickTime tracks are all sequenced to a common time base having unit time increments. The time increment may be 1/600 of a second, for example.

Tracks having lower numbers are displayed in front of tracks having higher numbers. For example the track “−20” is displayed in front of the track “0”. Commonly used tracks may include video and audio media, but media files may also include text tracks, chapter tracks, and sprite tracks, for example.

Each track includes a plurality of media samples, which are defined by data structures known as a QuickTime “Atoms”. The QuickTime Atom data structure is explained in greater detail in the document “QuickTime Movie Basics” ©Apple Computer Inc 2005 and 2006, and which is incorporated herein by reference. QuickTime media samples are of variable data size, and accordingly QuickTime atoms are also of variable data size.

Media samples are generally compressed in size by defining a keyframe sample including all data to be displayed, followed by a plurality of override samples, which include updates or changes from the keyframe sample. Accordingly override samples generally include only a portion of the media data included in a keyframe sample.

Sprite tracks facilitate interactivity in QuickTime movies by allowing sprites to be defined in the sequenced media. In computer graphics, a sprite is an image or animation that is integrated into a larger scene. Sprites are generally at least partially transparent and may be rotated and/or scaled.

In QuickTime, each sprite defined in a sprite track has properties that describe its location and appearance at a given time as displayed on the background of the sequenced media (commonly referred to as a “sprite world” or more simply a “stage”). QuickTime sprites may be visible or invisible and may be modified to cause the sprite to change appearance and/or to move around the stage.

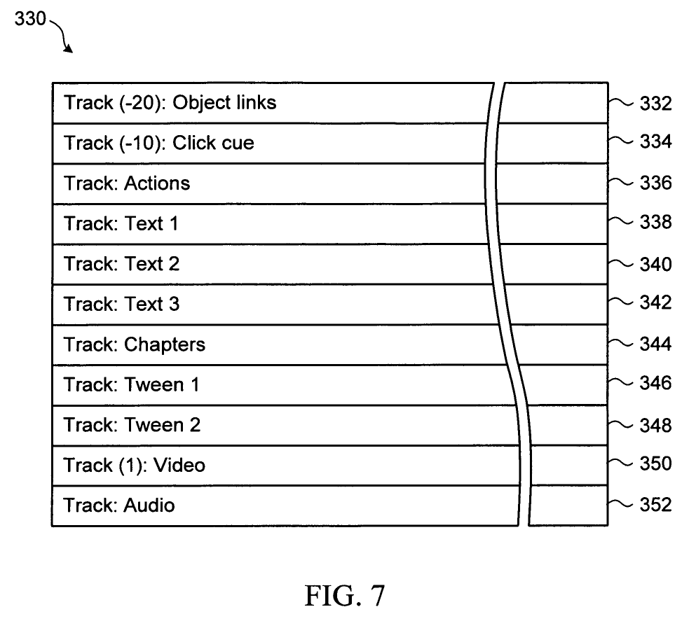

Referring to FIG. 7, a schematic representation of a QuickTime interactive sequenced media file produced using the VideoClix software product is shown generally at 330. The media file 330 includes an object links track 332, which is a sprite track having a layer number of “−20”. The object links track 332 has a single keyframe sample (not shown) at the beginning of the object links track which defines a circle base image (having an assigned image index of 1) and a rectangle base image (having an assigned image index of 2). In this embodiment, the circle and rectangle base images are invisible to the user of the client display apparatuses 104, 106, 108, or 110 when displaying the sequenced media.

The object links track 332 further includes one or more sprites defined in the keyframe sample at the beginning of the object links track. The sprites each have an image shape defined by the circle or the rectangle base image. Each sprite is generally associated with a moving or dynamic object in the sequenced media, such as an actor, vehicle, or other object displayed in the media player 170 at 184, as shown in FIG. 2. The sprite base shapes may be moved and/or geometrically distorted by applying a transformation matrix to the base image shape boundaries to produce a shape generally corresponding to the associated dynamic object position, size, and shape. For example, an actor's face may be associated with a sprite based on the circle base image and a transformation matrix may be applied to the circle base image to transform the circle into an oval shape. The transformation matrix may thus be populated with values for causing translation, rotation, scaling, and other arbitrary geometric distortions to the base image.

Each time the position, shape, or size of the sprite changes, the current media sample in the object links track 332 is ended and a new media sample is created in the track with updated data defining the changed sprite. Each media sample includes data Atoms for all sprites that have changed their attributes (e.g. size, shape, and position) in the new media sample.

The object links track 332 further includes scripts embedded in the keyframe sample at the beginning of the track. The scripts include instructions to be executed when the user selects a sprite associated with an object link (for example by rolling over or clicking on the sprite). In this embodiment, the object links track 332 includes a QuickTime script “kQTEventMouseEnter” (not shown), which is launched when the pointer is moved over a sprite without clicking one of the mouse buttons, causing associated actions such as displaying rollover text to be triggered.

The object links track 332 may further include a QuickTime script “kQTEventMouseClickEndTriggerButton”, which is launched when the user clicks a mouse button while the pointer is over the associated sprite, and then releases the mouse button. The object links track 332 further includes one or more atoms defining actions that are executed when the “kQTEventMouseClickEndTriggerButton” script is launched, such as causing a billing message to be transmitted over the network 140 to the billing server 150. Other actions may also be executed such as causing a web page content to be displayed in the second frame 180 (shown in FIG. 2).

The keyframe sample of the object links track 332 also includes a “kQTEventFrameLoaded” script, which causes track data variables, sprite data variables, the image index (1 for circle base image and 2 for rectangle base image), and the transformation matrix, to be initialized to match the stage defined at the beginning of the sequenced media.

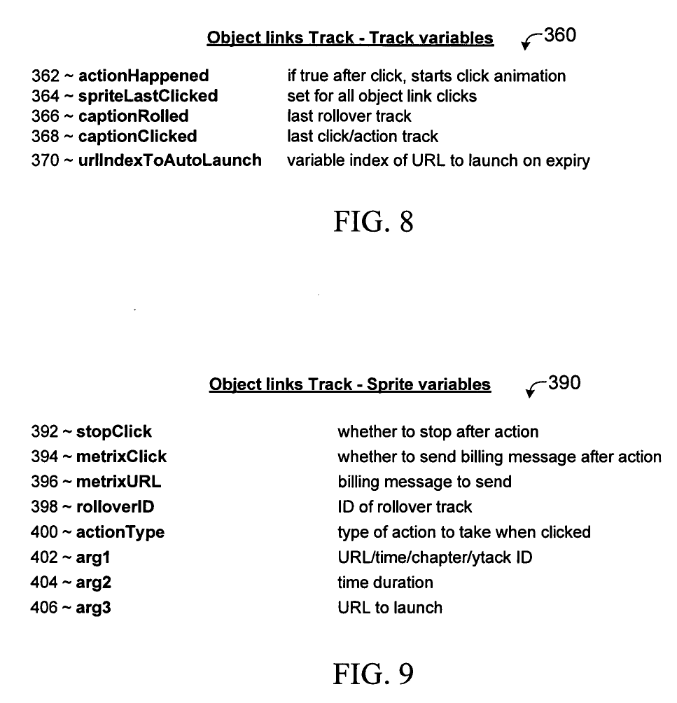

Referring to FIG. 8, the track data variables for the object links track 332 are shown generally at 360. The track data variables 360 include an “actionHappened” variable 362 for indicating that a click animation should be started in response to a user selecting an object link sprite, a “spriteLastClicked” variable 364 for identifying a last clicked on object link sprite, a “captionRolled” variable 366 for storing a text track number corresponding to a sprite last rolled over, a “captionClicked” variable 368 for storing a text track number corresponding to a sprite last clicked on, and a “urlIndexToAutoLaunch” variable 370 for storing an index of a URL to auto launch on expiry of the animation.

Referring to FIG. 9, each sprite includes a set of eight sprite data variables shown generally at 390. The sprite data variables 390 include a “stopClick” variable 392, which if set to true causes the sequenced media to be stopped after the billing message has been transmitted and any actions defined for the object link sprite has been performed. The sprite data variables 390 further include a “metrixClick” variable 394, which if set to true causes a billing message to be sent after the actions, a “metrixURL” variable 396 for storing a string representing the billing message, a “rolloverID” 398 for storing a rollover track layer number to be played in the event of a mouse rollover, an “actionType” variable 400 for storing a type of action to be taken when the sprite is clicked. The types of actions that may be triggered after the billing message has been transmitted include launching a URL, advancing the sequenced media to a specific time, advancing the sequenced media to a specific chapter, or displaying a text track, for example.

The sprite data variables 390 also include three data variables “arg1” 402, “arg2” 404, and “arg3” 406, each variable being associated with the action defined in the “actionType” variable 400. For example, when the type of action is launching a URL, the “arg1” variable 402 holds the URL of the website to be launched. When the type of action is to display text, the “arg1” variable 402 holds a text track ID to be displayed (for example one of the text tracks 338, 340, or 342), the “arg2” variable 404 holds a time duration for which the text track should be displayed, and the “arg3” variable 406 holds a URL that should be launched once the text track has been displayed for the time duration held in the “arg2” variable.

Advantageously, the object link sprites defined in the object links track 332, along with the sprite track data variables 390: are able to change position, thus providing an object link that follows an associated dynamic object, unlike conventional object links, which are static.

Referring back to FIG. 7 the media file 330 also includes a click cue track 334, which is a visible sprite track having a layer number of “−10”. The click cue track 334 includes display images for a plurality of frames defining a click cue animation (such as the click cue animation 192 shown in FIG. 2). In this embodiment the click cue track includes a single visible sprite at the location of the click cue animation 192, for displaying the click cue animation frames. The click cue track 334 further includes two embedded track data variables (not shown), which are set by the object links track 332, including an “animationIndex” variable for holding a index of the current displayed animation frame and a “captionDuration” variable for holding a duration value for which the caption is to be displayed (2 seconds, for example).

The click cue track 334 further includes an idle script, which executes every 1/10 second, for launching the click-cue animations in response to a user selection of the object link.

The media file 330 also includes a timed actions track 336, which is an invisible sprite track, but which has no actual sprites. The timed actions track 336 generally defines timed actions that happen at a specific time regardless of user input, such as displaying a user menu displaying possible user selections for viewing the sequenced media. The timed actions track 336 is broken up into samples that extend between each non-sprite action defined for the media. The timed actions track 336 further includes a “kQTEventFrameLoaded” script, which causes arguments associated with the non-sprite actions to be loaded at beginning of each sample.

The media file 330 also includes a plurality of text tracks. In the embodiment shown in FIG. 7, the media file 330 includes three text tracks 338, 340, and 342. Each text track defines a single text object having a configurable position, size, and text display specification.

The media file 330 further includes a chapters track 344, which is an invisible text track including samples having a duration corresponding to chapters in the media file. Each chapter track sample includes a name of the chapter and facilitates changing a displayed portion of the media file in response to selection of a specific chapter by the user.

The media file 330 also includes one or more tween tracks. In the embodiment shown in FIG. 7 there are two tween tracks 346 and 348. Tween tracks are useful for defining the position, shape and/or size of a sprite in the object links track 332 that change generally linearly between sequential samples of the sprite. Every sprite, which has a shape that is set to “tween” between samples has a tween track created for it. The tween track causes appropriate modifier atoms to be included in the object links track 332, such that sprite is appropriately transformed between the object links. Tween tracks reduce the amount of data necessary to cause a sprite to move with an associated dynamic object when the dynamic object moves in a generally linear fashion between two sequential sprite samples.

In some embodiments the video and/or audio tracks may be streamed from the RTSP server 232 implemented on the media server processor circuit 200 shown in FIG. 3. In such cases when the media file is created, a RTSP Uniform Resource Locator (URL) is included in the file and a video track 350 is added to the media file 330. In this case the video track 350 has a media sample of the same the length of the media and includes the RTSP URL.

In other embodiments where an RTSP server is not available for streaming the media data to the users, video data from a source media may be copied to the video track 350 of the media file 330, in which case the video data will be included in the media file. Similarly, audio data may also be copied from the source media to an audio track 352 of the media file 330.

In general, the media file 330 may also include general movie flags and data for controlling autoplaying of the media, whether the user is able to save the media file on the client display apparatus, full screen presentation flags, and looping flags, for example.

### Flash File Format

Flash format files provide similar functionality to QuickTime files. However in contrast to QuickTime, which allows variable time samples, Flash frames are of fixed duration. The first frame of the flash file includes embedded scripts, which define sprites for the media, including text and object link sprites, for example. Each subsequent frame also includes a script, which executes actions defined for that frame, if any.

Each sprite object defined on the stage has a sprite created for it with the same number of frames as the overall movie. The sprite is embedded in the first frame. At the beginning of each sprite frame in which the sprite shape and/or appearance change an appropriate shape object or tween object is defined using Flash bytecodes.

The Flash media file includes an “OnLoad” script to define variables similar to the variables shown in FIG. 8 and FIG. 9 for whether to stop after the click, the billing message to send, etc. These variables are set by scripts embedded into the frame, which include an ‘OnEnterFrame’ script for retrieving rollover position, size, text, and URL info when the sprite is rolled over, an ‘OnMouseDown’ script handler to send the billing message, start playing the click-cue animation, and to execute other additional actions if defined.

### Operation—Client Display Apparatus

### Displaying Interactive Sequenced Media

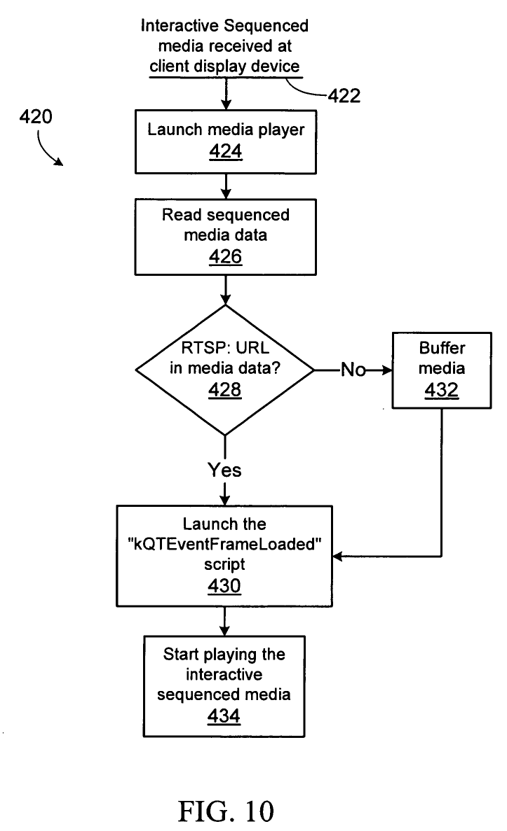

Referring to FIG. 10, a flowchart of blocks of code for directing the client display apparatus processor circuit 280 (shown in FIG. 6) to receive sequenced media from the media server 102 is shown generally at 420. The blocks generally represent codes that may be read from the computer readable medium 294, and stored in the program memory 284, for directing the microprocessor 282 to perform various functions related to displaying the sequenced media file. The process is described with reference to QuickTime media file formats, although it should be readily apparent that the process may also be applied to Flash file formats with some minor modification.

As described above in connection with FIG. 5, when media server 102 receives a media request from one of the client display apparatuses 104, 106, 108, or 110, the server 102 responds by locating the requested media and then transmits the media data to the client display apparatus. The process 420 begins at 422, when interactive sequenced media is received at the interface 300 of the client display apparatus processor circuit 280 (as shown in FIG. 6).

Block 424 then directs the microprocessor 282 to launch the media player program codes 312 to display the media player window on the display 112, 114, 116, or 118 of the client display apparatus display 104, 106, 108, or 110. The media player may be a QuickTime or Flash media player, for example.

The process continues at block 426, which directs microprocessor 282 to read a first portion of the sequenced media data received at the interface 300. In general the first portion of the sequenced media data includes information in connection with the number of tracks in the media file, the length of the media file, sprite tracks (332, 334, 336), text tracks (338, 340, 342), the chapters track 344, the tween tracks (346 and 348), and the video track 350, and the audio track 352.

If at block 428, the video track 350 having a RTSP URL is included, then the process continues at block 430, which directs the microprocessor 282 to launch the “kQTEventFrameLoaded” script, which causes track data variables, sprite data variables, the image index, and the transformation matrix, to be set appropriately for each sample in the object links track 332, as described above.

The process then continues at block 434, which directs the microprocessor to start playing the interactive sequenced media.

If at block 428, the video track 350 does not include a RTSP URL, then the process continues at block 432, which directs the microprocessor 282 to save video and/or audio data into the RAM 286 to buffer the data stream from the media server 102. The buffer size may depend on network connection speeds and/or network congestion through the network 140 and is generally controlled by the media player. When sufficient media data has been buffered, the process continues at blocks 430 and 432, as described above.

The sequenced media is displayed in the first frame 178 of the media player 170 (shown in FIG. 2) and any timed actions included in the actions track 336 (shown in FIG. 7) are launched at their assigned times. Such timed actions may include displaying text captions at defined times or displaying a menu offering the user a choice of options (such as a choice of chapters to view, for example).

### Rollover and Click Events

In general when the user of one of the client display apparatuses 104, 106, 108, or 110 selects an object link associated with a dynamic object in the sequenced media, either by rolling over the dynamic object or by clicking on the dynamic object, then a script associated with the event is launched. The script reads the values of the sprite data variables 390 (shown in FIG. 9) and sets values of the track data variables 360 (shown in FIG. 8) accordingly.

The track data variables 360 are referenced by the idle script, which as described above is executed every 1/10 second. If the “actionHappened” variable 362 is true at the time the idle script executes then an animation is started. For rollover events, the animation includes a rollover text caption displayed over the dynamic object. For click events, the animation includes the click-cue animation 192 (shown in FIG. 2).

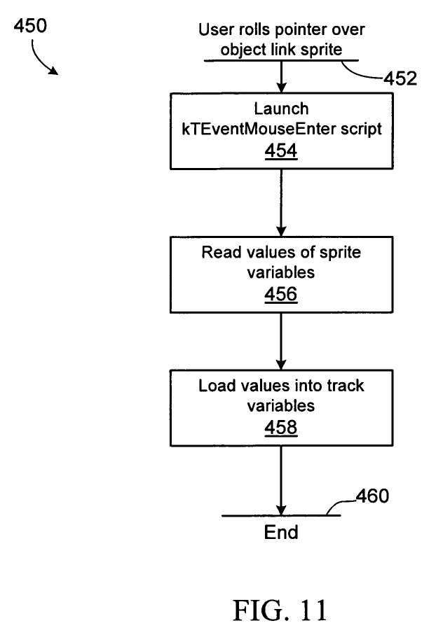

Referring to FIG. 11, a flowchart of blocks of code for directing the client display apparatus processor circuit 280 (shown in FIG. 6) to process user rollovers of the object link sprites defined in the object links track 332, is shown generally at 450.

The process begins at 452 when the user pointer moves over one of the sprites defined in the object link track 332. Block 454 directs the microprocessor 282 to cause the “ktEventMouseEnter” script to be launched.

The process then continues at block 456 which directs the microprocessor 282 to read the values of the sprite data variables 390 for the object link sprite that was rolled over by the user's pointer.

Block 458 then directs the microprocessor 282 to load values into the track data variables 360 (shown in FIG. 8). The value of the “actionHappened” variable 362 is set to “true”, the value of the “spriteLastClicked” variable 364 is set to “False” (because the sprite was rolled over, not clicked), the value of the “captionRolled” variable 366 is set to the track ID held in the rolloverID variable 398 for the sprite that was rolled over, the value of “captionClicked” variable is set to “nill”, and the value of the “urlIndexToAutoLaunch” is set to the value held in the “arg3” variable 406.

The process 450 then ends at 460.

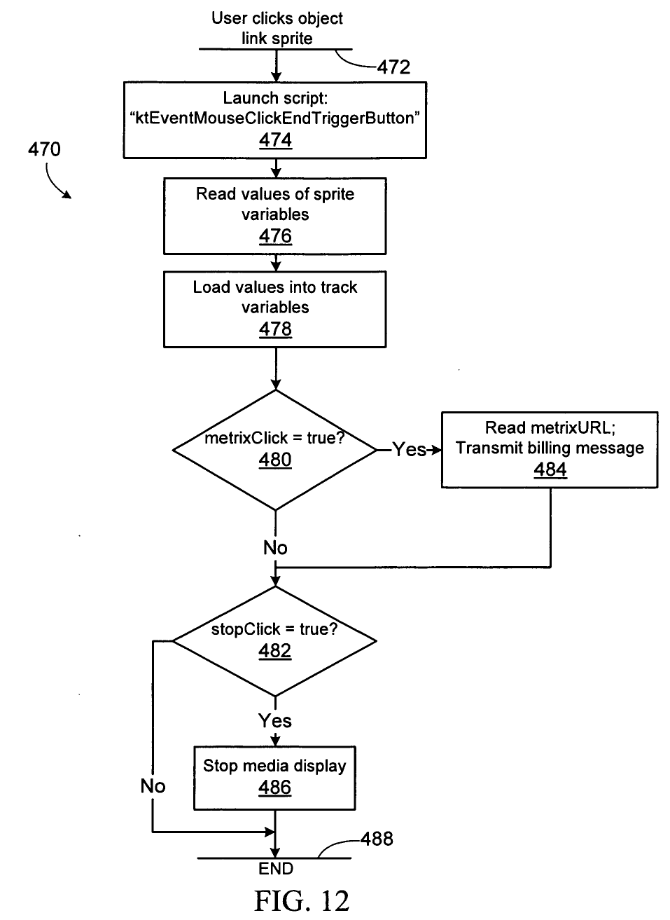

Referring to FIG. 12, a flowchart of blocks of code for directing the client display apparatus processor circuit 280 (shown in FIG. 6) to process user clicks of the object link sprites defined in the object links track 332, is shown generally at 470.

The process begins at 472 when the user moves the pointer over a sprite, clicks inside the sprite, and then releases, the mouse button.

Block 474 directs the microprocessor 282 to cause the script “ktEventMouseClickEndTriggerButton” to be launched.

Block 476 directs the microprocessor 282 to read the values of the sprite data variables 390 (shown in FIG. 9).

Block 478 then directs the microprocessor 282 to load values into the track data variables 360 (shown in FIG. 8). The value of the “actionHappened” variable 362 is set to “true”, the value of the “spriteLastClicked” variable 364 is set to “True”, the value of the “captionRolled” variable 366 is set to “nill”, the value of captionClicked variable is set to the track ID (−10) of the click-cue animation (track 334, shown in FIG. 7), and the value of the “urlIndexToAutoLaunch” is set to the value held in the “arg3” variable 406.

The process continues at block 480, which directs the microprocessor 282 to check whether the “metrixClick” variable 394 is “False”, in which case the process continues at block 482.

Block 482 directs the microprocessor 282 to check whether the “stopClick” variable 392 is true, in which case the process continues at block 486. Block 486 directs the microprocessor 282 to cause the media display to be stopped.

If at block 482 the “stopClick” variable is “False”, then the media playback continues and the process 470 ends at 488.

If at block 480, the “metrixClick” variable is “True”, then the process continues at block 484, which directs the microprocessor 282 to read the “metrixURL” variable 396.

### Billing Message Format

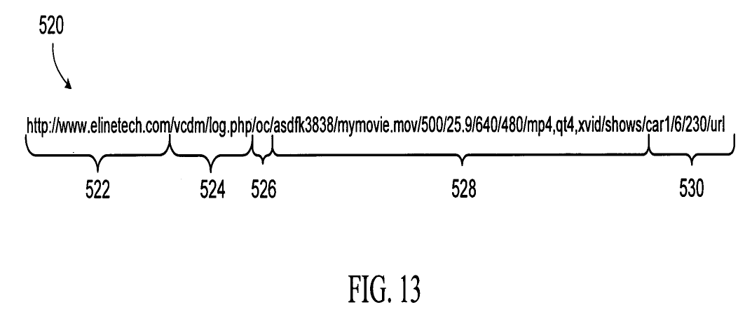

The “metrixURL” variable 396 holds a string value defining the billing message. Referring to FIG. 13, an exemplary billing message is shown generally at 520. In this embodiment, the billing message 520 includes a first portion 522, a second portion 524, a third portion 526, a fourth portion 528, and a fifth portion 530.

The first portion 522 of the billing message 520 includes a URL for the billing server 150, and causes billing messages transmitted by the client display apparatuses 104, 106, 108, and/or 110, to be correctly routed over the network 140 to the billing server 150.

The second portion 524 of the billing message 520 includes a location and a script name of a script stored on the billing server 150. The script is operable to extract information fields from the billing messages received at the billing server 150.

The third portion 526 of the billing message 520 includes a type code, which may be either “oc” or “pb”. A type code of “oc” indicates that the billing message was sent in response to an object click. A type code of “pb” indicates that the billing message was sent in response to a tag embedded in the media file at a specific time in the media to indicate that the user has viewed the media up to and including this time.

The fourth portion 528 of the billing message 520 includes display condition information including various playback conditions on the client display apparatuses 104, 106, 108, or 110. For example, the fourth portion may include the following display condition information:
a media serial number;
a media name (for example a playing URL);
a media length (in seconds);
number of frames per second;
width of the media in pixels;
height of the media in pixels;
compression/decompression (codecs) used for encoding media; and
a media category (set by media content provider).

The fifth portion 530 of the billing message 520 includes object information. When the type code is “oc”, the object information in the fifth portion 530 includes information identifying the dynamic object that was clicked by the user. The information identifying the dynamic object may include an object identifier for example. The object information included in the fifth portion 530 may also include some or all of the following information:
an object viewing duration (seconds);
a number of pixels occupied by object on screen; and
a type of additional actions launched after the billing message is transmitted.

When the type code is “pb”, the message is generated in response to the user of one of the client display apparatuses 104, 106, 108, or 110 viewing the media file to a specific playback point in the file. For example, the message of type “pb” may be generated and transmitted when user has viewed 50% of the media file, and/or to the “END” of the media file, respectively.

Referring back to FIG. 12, block 484 further directs the microprocessor 282 to cause the interface 300 (shown in FIG. 6) to transmit the billing message 520 over the network 140 to the billing server 150. The process then continues at blocks 482, 486 and 488 as described above.

### Idle Script Operation

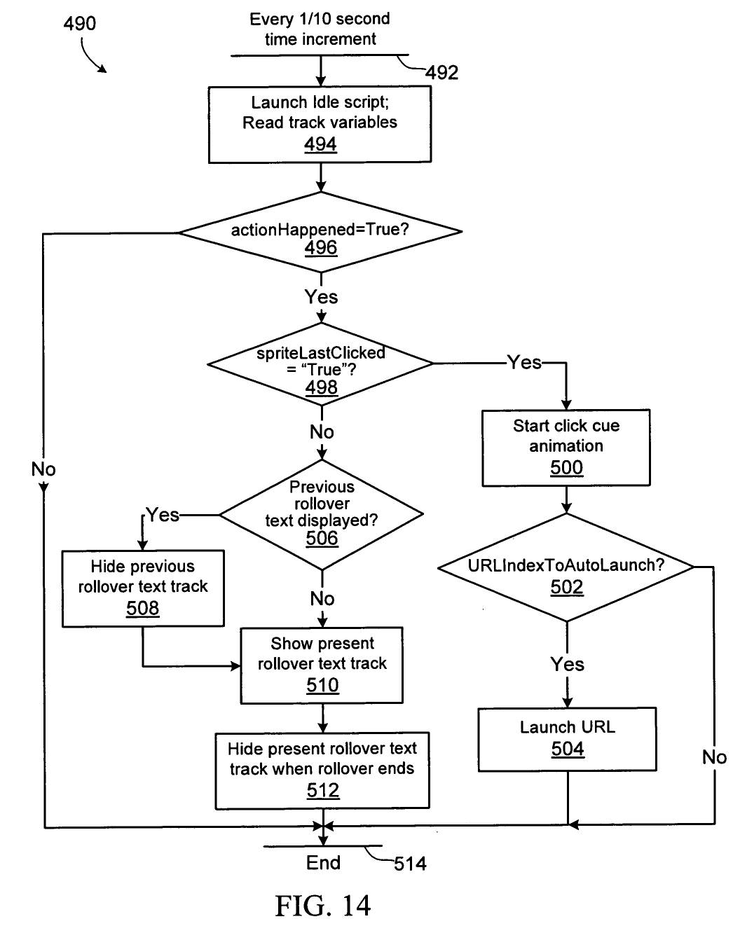

Referring to FIG. 14, a flowchart of blocks of code for directing the client display apparatus processor circuit 280 (shown in FIG. 6) to further process user rollovers and clicks of the object link sprites defined in the object links track 332, is shown generally at 490.

In this embodiment, the process begins at 492, at each 1/10 second time interval while the media file is being played. Block 494 then directs the microprocessor 282 to launch the idle script.

The process continues at block 496 which directs the microprocessor 282 to determine whether the “actionHappened” track variable 362 is “True”. If the “actionHappened” track variable 362 is not “True”, then the process ends at 514 (i.e. no click animation is displayed).

If the “actionHappened” track variable 362 is “True”, then the process continues at block 498 which directs the microprocessor 282 to check whether the “spriteLastClicked” variable 364 is “True”, in which case the process continues at block 500.

Block 500 directs the microprocessor 282 to start the click cue animation (stored in the media file as track 334 shown in FIG. 7), which causes the click cue animation 192 to be displayed in the in the first frame 178 of the media player 170 (shown in FIG. 4).

The process then continues at block 502, which directs the microprocessor 282 to check whether the “urlIndexToAutoLaunch” variable 370 includes a URL string. If yes, then the process continues at block 504, which directs the microprocessor 282 to launch the URL. The process 490 then ends at 514.

If at block 502, the “urlIndexToAutoLaunch” variable 370 does not include a URL string, then the process then ends at 514.

If at block 498, the “spriteLastClicked” variable 364 is “False”, the process continues at block 506. Block 506 directs the microprocessor 282 to check whether a previous rollover text caption is being displayed. If no previous rollover text caption is being displayed, then the process continues at block 510, which directs the microprocessor 282 to read the value of the “captionRolled” variable 366 and to display the referenced text track (track 338 in FIG. 7, for example).

The process continues at 512, which directs the microprocessor 282 to hide the text track 338 when the pointer moves off the associated sprite. The process then ends at 514.

If at block 506, a previous rollover caption text is being displayed, the process continues at block 508, which directs the microprocessor 282 to hide the previous rollover track (for example by setting the track layer number to 32767), before continuing at block 510, 512, and 514, as described above.

Referring back to FIG. 11, optionally in some embodiments (not shown), the billing message 520 may also be transmitted in response to the object link being rolled over by the user of one of the client display apparatuses 104, 106, 108, or 110. In such an embodiment, the process 450 may further include further blocks (such as the blocks 480 and 484 shown in FIG. 12), which may be inserted and executed after block 458.

### Billing Server

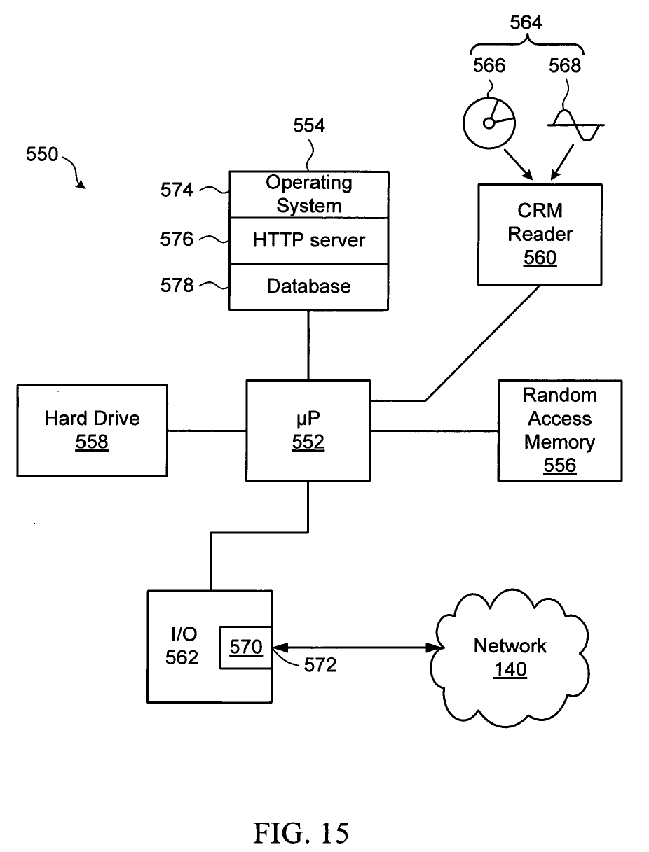

Referring to FIG. 15, in one embodiment the billing server 150 may be implemented using a processor circuit shown generally at 550. The processor circuit 550 includes a microprocessor 552, a program memory 554, a random access memory (RAM) 556, a hard drive 558, a computer readable medium (CRM) reader 560, and an input output port (I/O) 562, all of which are in communication with the microprocessor 552.

The CRM reader 560 facilitates loading program codes into the program memory 554 from a computer readable medium 564, such as a CD ROM disk 566, or a computer readable signal 568, such as may be received over a network such as the internet, for example.

Program codes for directing the microprocessor 552 to carry out various functions are stored in the program memory 554, which may be implemented as a random access memory (RAM), and/or a hard disk drive (HDD), or a combination thereof. In this embodiment the program memory 554 includes a first store 574 for storing program codes for directing the microprocessor 552 to provide various operating system functions, a second store 576 for storing program codes for directing the microprocessor 552 to implement a hyper text transfer protocol (HTTP) server, and a third store 578 for storing program codes for directing the microprocessor 552 to provide database functions.

The hard drive 558 may include a redundant array of independent disks (RAID), which offers increased performance and fault tolerance over conventional single hard drives. In general the hard drive provides bulk storage for storing database tables as described later herein.

The I/O 562 includes an interface 570 having an input/output 572 for receiving data from the client display apparatuses 104, 106, 108, and 110 over the network 140. The interface 570 may include an Ethernet interface, for example.

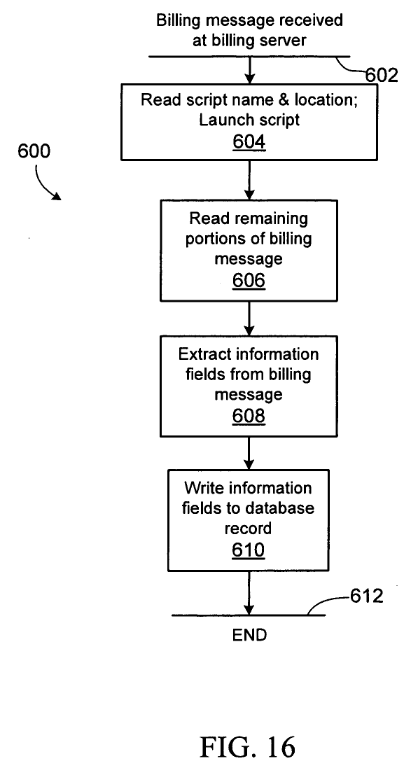

Referring to FIG. 16, a flowchart of blocks of code for directing billing server processor circuit 550 to receive and process billing messages from the client display apparatuses 104, 106, 108, or 110 is shown generally at 600.

The process begins at 602 when a billing message 520 (shown in FIG. 13) is received from one of the client display apparatuses 104, 106, 108, or 110 at the interface 570 of the billing server processor circuit 550.

Block 604 directs the microprocessor 552 to read the location and name of the script from the second portion 524 of the billing message 520. Block 604 then directs the microprocessor 552 to launch the script.

Block 606 then directs the microprocessor 552 to read the remaining portions 526, 528, and 530 of the billing message 520. Block 608 then directs the microprocessor 552 to extract the various information fields from the billing message 520. The process continues at block 608, which directs the microprocessor 552 to cause the information fields to be written into corresponding fields in a billing entry, which is stored on the hard drive 558.

### Billing Server Tables

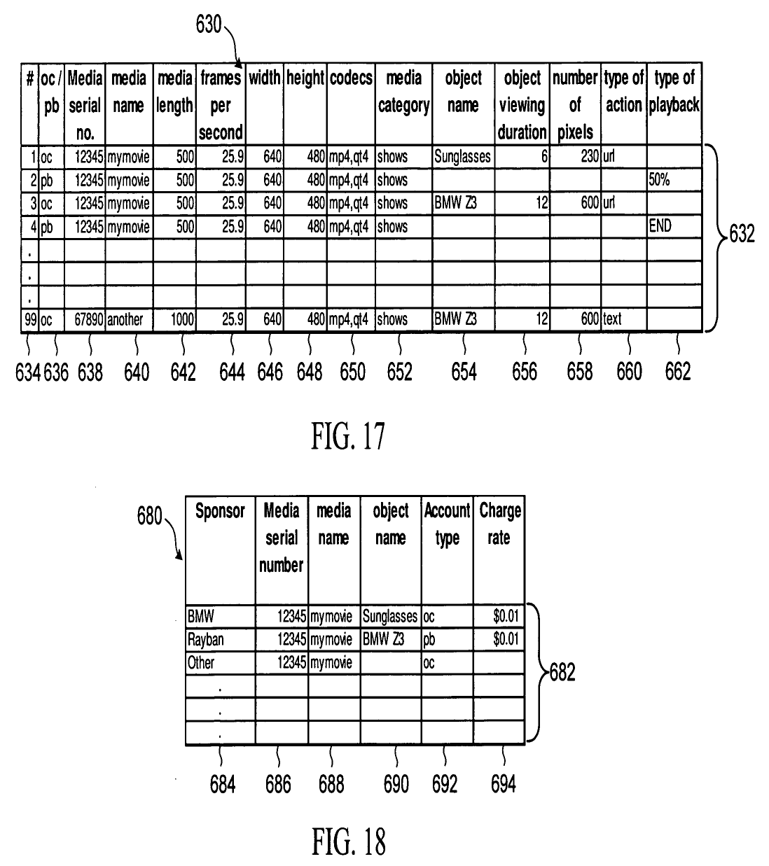

Referring to FIG. 17, an exemplary billing entry table is shown generally at 630. The billing entry table 630 includes a plurality of billing entries 632 stored on the hard drive 558. Each billing entry 632 includes a field 634 for holding a database record number, a field 636 for holding the type code, a field 638 for holding the media serial number, a field 640 for holding the media name, a field 642 for holding the media length, a field 644 for holding the frames per second of the media, a field 646 for holding the width in pixels of the media, a field 648 for holding the height in pixels of the media, a field 650 for holding the compression/decompression used to produce the media, a field 652 for holding the media category, a field 654 for holding the object identifier of an object that was selected, a field 656 for holding the viewing duration of the object, a field 658 for holding the number of pixels occupied by the object on the screen, a field 660 for holding the type of action, and a field 662 for holding the type of playback.

Each time a billing message is received at the interface 570 of the billing server processor circuit 550, the process 600 (shown in FIG. 16) is initiated, and a new billing entry 632 is added to the database. The database may be a Microsoft SQL database, for example.

Referring to FIG. 18, the billing server database also includes a sponsor table, shown generally at 680. In general, at least some dynamic objects 184 (shown in FIG. 2) have associated sponsors. The sponsor is generally an individual or entity who has agreed to be charged a fee when users of client display apparatuses 104, 106, 108, or 110 select the object link associated with a sponsored dynamic object in the sequenced media. In some embodiments, the sponsor may be a company that manufactures or sells the linked dynamic object product (for example, the BMW motor vehicle in FIG. 2 may be sponsored by the BMW of North America, LLC company).

Alternatively, in other embodiments the sponsor may not be directly related to the linked dynamic object product (for example, the BMW motor vehicle may be sponsored by a car rental company, who rent BMW automobiles to the public).

The sponsor table 680 includes a plurality of sponsor records 682 stored on the hard drive 558. Each sponsor record 682 includes a field 684 for holding a sponsor name, a field 686 for holding a media file serial number, a field 688 for holding a name of the media file, a field 690 for holding an object identifier sponsored by the sponsor, a field 692 for holding an account type of the sponsor, and a field 694 for holding a charge rate per selection for the sponsor. The account type field 692 includes information identifying whether the sponsor pays for object clicks or playback or both.

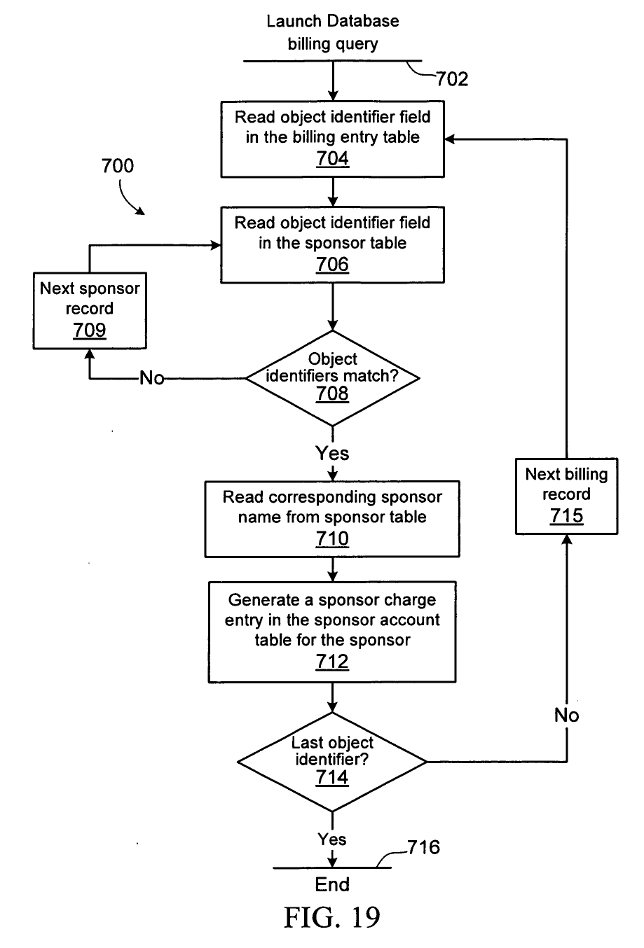

Referring to FIG. 19, a flowchart of blocks of code for directing billing server processor circuit 550 to cause an account to generated and sent to a sponsor of one or more dynamic objects is shown generally at 700.

The process begins at 702, when the billing server 150 initiates billing of the sponsors of the dynamic objects. The billing may either be run on a schedule at a specific time and date each month, or may be initiated by an operator of the billing server 150.

Block 704 directs the microprocessor 552 to read the contents of the object identifier field 654 of the first billing entry 632 in the billing entry table 630. Block 706 then directs the microprocessor 552 to read the contents of each of the object identifier fields 690 in the sponsor records 682 in the sponsor table 680.

Block 708 directs the microprocessor 552 to check whether the value in object identifier 690 read from the sponsor table 680 matches the object identifier 654 read from the billing entry table 630. If the object identifiers do not match, then the process continues at block 706, where the next object identifier field 690 is read as described above.

If at block 708, the object identifier fields match then the process continues at block 710, which directs the microprocessor 552 to read the corresponding sponsor name 684, media serial no. 686, media name 688, account type 692, and charge rate 694.

Block 712 then directs the microprocessor 552 to generate a billing record in a sponsor account table associated with the sponsor name read from the filed 684 stored in the database.

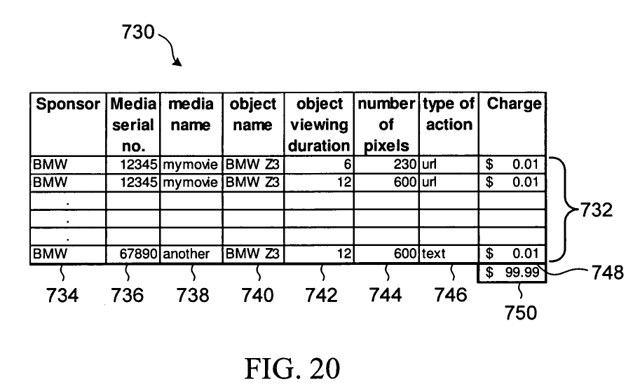

Referring to FIG. 20, an exemplary sponsor account table is shown generally at 730. The sponsor account table 730 includes a plurality of sponsor charge entries 732, each charge corresponding to an object click of a dynamic object that has been sponsored by the sponsor. The sponsor charge entries 732 each include a field 734 for holding the sponsor name, a field 736 for holding the media serial number in which the object was viewed and clicked, a field 738 for holding the name of the movie in which the object was clicked, a field 740 for holding the name of the object, a field 742 for holding the object viewing duration, a field 744 for holding the number of pixels occupied by the object on the screen, a field 746 for holding the type of action that generated the billing entry, and a field 748 for holding a charge included in the sponsor account table as a result of the user of one of the client display apparatuses 104, 106, 108, or 110 selecting the object link.

Referring back to FIG. 19, block 714 directs the microprocessor 552 to check whether the object identifier 654 read at block 704 is the last object identifier, in which case the process 700 ends at 716. If the object identifier 654 read at block 704 is not the last object identifier, then the process 700 continues at block 704, where the next object identifier is read and the blocks 706-714 are repeated.

The process 700 generates one or more sponsor charge entries 732 in the sponsor account table 730 for each sponsor in the sponsor table 680 that is matched to one or more of the entries 632 in the billing entry table 630. The sponsor account table 730 further includes a total field 750 for holding a total of the charges 748 that will be billed to the sponsor of the dynamic object or objects.

In general, the process 700 may be coded as a database query in a query language format specific to the database application used for managing the tables 630, 680, and 730. For example, where the database is a Microsoft SQL database, the query language may be Structured Query Language (SQL).

Advantageously, the process 700 bills charges for each object sponsor who has sponsored a dynamic object in a sequenced media file that has been clicked by one or more of the users of the client display apparatuses 104, 106, 108, or 110. The bill includes charge information generally as shown in the sponsor account table 730 shown in FIG. 20, and may optionally include further details of the user selection from billing entry fields such as the media length field 642, frames per second field 644, width field 646, height field 648, codecs used field 650, and the media category field 652, for example. The sponsor may have sponsored a plurality of dynamic objects in plurality of sequenced media, and the optional information may be helpful to the sponsor for refining a marketing campaign.

While specific embodiments of the invention have been described and illustrated, such embodiments should be considered illustrative of the invention only and not as limiting the invention as construed in accordance with the accompanying claims.

What is claimed is:

1. A method for displaying interactive sequenced media on a client display apparatus, the method comprising:
causing at least one dynamic object in the interactive sequenced media to be displayed on the client display apparatus, said dynamic object having an associated object link that follows said dynamic object; and
causing a billing message to be transmitted over a computer network to a billing server in response to a user of the client display apparatus selecting said object link.

2. The method of claim 1 further comprising receiving the interactive sequenced media over the computer network from a media server.

3. The method of claim 1 wherein causing said at least one dynamic object to be displayed comprises displaying a first media track in the interactive sequenced media, said first media track comprising data defining said dynamic object.

4. The method of claim 3 further comprising displaying a second media track having at least one invisible shape and further comprising modifying a position of said invisible shape to cause said invisible shape to follow to said dynamic object, said invisible shape defining a display area on the client display apparatus configured to activate said object link in response to said selecting.

5. The method of claim 4 further comprising modifying at least one of a size and a geometrical distortion of said invisible shape to cause the shape to generally correspond to the dynamic object.

6. The method of claim 1 further comprising displaying an animation in a display area of the client display apparatus in response to said selecting.

7. The method of claim 1 further comprising generating a request for content associated with the object link in response to said selecting.

8. The method of claim 7 further comprising displaying said content on the client display apparatus.

9. The method of claim 8 wherein said interactive sequenced media is displayed in a first portion of a display area of the client display apparatus and wherein displaying said content comprises displaying said content in a second portion of the display area of the client display apparatus.

10. The method of claim 1 wherein causing said billing message to be transmitted in response to said selecting comprises causing said billing message to be transmitted in response to at least one of:
the user causing a pointer displayed in a display area of the client display apparatus to move over said object link; and
the user actuating an actuator on the client display apparatus while said pointer is over said object link.

11. The method of claim 10 further comprising causing a text message to be displayed over said interactive sequenced media in response to the user causing said pointer to move over said object link.

12. The method of claim 1 further comprising stopping display of the interactive sequenced media in response to said selecting.

13. The method of claim 1 wherein transmitting said billing message comprises transmitting:
a network location of the billing server on the network; and
information identifying said dynamic object selected by the user of the client display apparatus.

14. The method of claim 13 wherein transmitting said information identifying said dynamic object comprises transmitting at least one of:
an object identifier;
a time duration for which the dynamic object was displayed;
a number of display pixels occupied by the dynamic object when displayed; and
information identifying an additional action performed in response to said selecting.

15. The method of claim 13 wherein transmitting said billing message further comprises transmitting display condition information associated with displaying the interactive sequenced media on the client display apparatus.

16. The method of claim 15 wherein transmitting said display condition information comprises transmitting at least one of:
a serial number associated with the interactive sequenced media;
a name associated with the interactive sequenced media;
a length of the interactive sequenced media;
a number of frames per second associated with the interactive sequenced media;
a display area size of a media viewer used on the client display apparatus to display the interactive sequenced media;
a video compression/decompression algorithm (codec) associated with the interactive sequenced media;
an audio compression/decompression algorithm (codec) associated with audio content in the interactive sequenced media;
a category associated with the interactive sequenced media; and
information indicating that the user has viewed a first portion of the interactive sequenced media.

17. The method of claim 13 wherein transmitting said billing message further comprises transmitting a location and a name of a script stored on the billing server, said script being operable to read and interpret said billing message.

18. A computer readable medium encoded with instructions for directing a processor circuit to display interactive sequenced media on a client display apparatus, the instructions comprising instructions for directing the processor circuit to:
cause at least one dynamic object in the interactive sequenced media to be displayed on the client display apparatus, said dynamic object having an associated object link that follows said dynamic object; and
cause a billing message to be transmitted over a computer network to a billing server in response to a user of the client display apparatus selecting said object link.

19. A client display apparatus for displaying interactive sequenced media, the apparatus comprising:
means for causing at least one dynamic object in the interactive sequenced media to be displayed, said dynamic object having an associated object link that follows said dynamic object; and
means for causing a billing message to be transmitted over a computer network to a billing server in response to a user of the client display apparatus selecting said object link.

20. The apparatus of claim 19 wherein said means for transmitting said billing message comprises means for transmitting:
a network location of the billing server on the network; and
information identifying said dynamic object selected by the user of the client display apparatus.

21. The apparatus of claim 20 wherein said means for transmitting said information identifying said dynamic object comprises means for transmitting at least one of:
an object identifier;
a time duration for which the dynamic object was displayed;
a number of display pixels occupied by the dynamic object when displayed; and
information identifying an additional action performed in response to said selecting.

22. The apparatus of claim 20 wherein said means for transmitting said billing message further comprises means for transmitting display condition information associated with displaying the interactive sequenced media on the client display apparatus.

23. The apparatus of claim 22 wherein said means for transmitting said display condition information comprises means for transmitting at least one of:
a serial number associated with the interactive sequenced media;
a name associated with the interactive sequenced media;
a length of the interactive sequenced media;
a number of frames per second associated with the interactive sequenced media;
a display area size of a media viewer used on the client display apparatus to display the interactive sequenced media;
a video compression/decompression algorithm (codec) associated with the interactive sequenced media; and
an audio compression/decompression algorithm (codec) associated with audio content in the interactive sequenced media; and
a category associated with the interactive sequenced media; and
information indicating that the user has viewed a first portion of the interactive sequenced media.

24. The apparatus of claim 20 wherein said means for transmitting said billing message further comprises means for transmitting a location and a name of a script stored on the billing server, said script being operable to read and interpret said billing message.

25. A client display apparatus for displaying interactive sequenced media, the apparatus comprising a processor circuit operably configured to:
cause at least one dynamic object in the interactive sequenced media to be displayed, said dynamic object having an associated object link that follows said dynamic object; and
cause a billing message to be transmitted over a computer network to a billing server in response to a user of the client display apparatus selecting said object link.

26. The apparatus of claim 25 further comprising an interface for receiving the interactive sequenced media over the computer network from a media server.

27. The apparatus of claim 25 wherein said processor circuit is operably configured to display a first track in the interactive sequenced media, said first media track comprising data defining said dynamic object.

28. The apparatus of claim 27 wherein said processor circuit is operably configured to display a second media track having at least one invisible shape and said processor circuit is further operably configured to modify a position of said invisible shape to cause said invisible shape to follow to said dynamic object, said invisible shape defining a display area on the client display apparatus configured to activate said object link in response to said selecting.

29. The apparatus of claim 28 wherein said processor circuit is operably configured to modify at least one of a size and a geometrical distortion of said invisible shape to cause the shape to generally correspond to the dynamic object.

30. The apparatus of claim 25 wherein said processor circuit is operably configured to display an animation in a display area of the client display apparatus in response to said selecting.

31. The apparatus of claim 25 wherein said processor circuit is operably configured to generate a request for content associated with the object link in response to said selecting.

32. The apparatus of claim 31 wherein said processor circuit is operably configured to display said content on the client display apparatus.

33. The apparatus of claim 32 wherein said processor circuit is operably configured to display said interactive sequenced media in a first portion of a display area of the client display apparatus and wherein said means for displaying said content comprises means for displaying said content in a second portion of the display area of the client display apparatus.

34. The apparatus of claim 25 wherein said processor circuit is operably configured to cause said billing message to be transmitted in response to at least one of:
the user causing a pointer displayed in a display area of the client display apparatus to move over said object link; and
the user actuating an actuator on the client display apparatus while said pointer is over said object link.

35. The apparatus of claim 34 wherein said processor circuit is operably configured to cause a text message to be displayed over said interactive sequenced media in response to the user causing said pointer to move over said object link.

36. The apparatus of claim 25 wherein said processor circuit is operably configured to stop display of the interactive sequenced media in response to said selecting.

37. The apparatus of claim 25 wherein said billing message comprises:
a network location of the billing server on the network; and
information identifying said dynamic object selected by the user of the client display apparatus.

38. The apparatus of claim 37 wherein said information identifying said dynamic object comprises at least one of:
an object identifier;
a time duration for which the dynamic object was displayed;
a number of display pixels occupied by the dynamic object when displayed; and
information identifying an additional action performed in response to said selecting.

39. The apparatus of claim 37 wherein said processor circuit is operably configured to transmit display condition information associated with displaying the interactive sequenced media on the client display apparatus.

40. The apparatus of claim 39 wherein said display condition information comprises at least one of:
a serial number associated with the interactive sequenced media;
a name associated with the interactive sequenced media;
a length of the interactive sequenced media;
a number of frames per second associated with the interactive sequenced media;
a display area size of a media viewer used on the client display apparatus to display the interactive sequenced media;
a video compression/decompression algorithm (codec) associated with the interactive sequenced media; and
an audio compression/decompression algorithm (codec) associated with audio content in the interactive sequenced media; and
a category associated with the interactive sequenced media; and
information indicating that the user has viewed a first portion of the interactive sequenced media.

41. The apparatus of claim 37 wherein said billing message further comprises a location and a name of a script stored on the billing server, said script being operable to read and interpret said billing message.

42. A method for billing a sponsor of a dynamic object, the method comprising:
receiving a billing message at a billing server, said billing message representing user selection of an object link that follows the dynamic object displayed in interactive sequenced media on a client display apparatus, said billing message including a dynamic object identifier identifying the dynamic object; and
associating a billing entry with a sponsor account associated with said dynamic object identifier to make a charge to said sponsor account as a result of said user selecting the object link.

43. The method of claim 42 wherein receiving said billing message further comprises receiving at least one of:
a time duration for which the dynamic object was displayed;
a number of display pixels occupied by the dynamic object when displayed; and
information identifying an additional action performed in response to said selecting.

44. The method of claim 42 wherein receiving said billing message further comprises receiving display condition information associated with displaying the interactive sequenced media on the client display apparatus.

45. The method of claim 44 wherein receiving said display condition information comprises receiving at least one of:
a serial number associated with the interactive sequenced media;
a name associated with the interactive sequenced media;
a length of the interactive sequenced media;
a number of frames per second associated with the interactive sequenced media;
a display area size of a media viewer used on the client display apparatus to display the interactive sequenced media;
a video compression/decompression algorithm (codec) associated with the interactive sequenced media; and
an audio compression/decompression algorithm (codec) associated with audio content in the interactive sequenced media; and
a category associated with the interactive sequenced media; and
information indicating that the user has viewed a first portion of the interactive sequenced media.

46. The method of claim 42 wherein receiving said billing message further comprises receiving a location and a name of a script stored on the billing server, said script being operable to read and interpret said billing message.

47. The method of claim 42 further comprising storing said dynamic object identifier in a billing entry table in a database.

48. The method of claim 47 wherein associating said billing entry with a sponsor account comprises reading said dynamic object identifier stored in said billing entry table and locating a sponsor record having a corresponding dynamic object identifier, said sponsor record being stored in a sponsor table in the database.

49. The method of claim 48 wherein said locating further comprises reading a sponsor name field in said sponsor record and causing a charge entry to be added to a sponsor account table stored in the database.

50. The method of claim 48 wherein causing said charge entry to be added comprises causing a charge entry to be added to said sponsor account table, said charge entry including display condition information associated with displaying the interactive sequenced media on the client display apparatus.

51. The method of claim 50 further comprising reading said sponsor account table and causing a bill to be produced for sending to said sponsor.

52. A computer readable medium encoded with codes for directing a processor circuit to bill a sponsor of a dynamic object, the codes directing the processor circuit to:
receive a billing message at a billing server, said billing message representing user selection of an object link that follows the dynamic object displayed in interactive sequenced media on a client display apparatus, said billing message including a dynamic object identifier identifying the dynamic object; and
associate a billing entry with a sponsor account associated with said dynamic object identifier to make a charge to said sponsor account as a result of said user selecting the object link.

53. A billing server apparatus for billing a sponsor of a dynamic object, the apparatus comprising:
means for receiving a billing message at a billing server, said billing message representing user selection of an object link that follows the dynamic object displayed in interactive sequenced media on a client display apparatus, said billing message including a dynamic object identifier identifying the dynamic object; and
means for associating a billing entry with a sponsor account associated with said dynamic object identifier to make a charge to said sponsor account as a result of said user selecting the object link.

54. The apparatus of claim 53 wherein said means for receiving said billing message further comprises means for receiving at least one of:
a time duration for which the dynamic object was displayed;
a number of display pixels occupied by the dynamic object when displayed; and
information identifying an additional action performed in response to said selecting.

55. The apparatus of claim 53 wherein said means for receiving said billing message further comprises means for receiving display condition information associated with displaying the interactive sequenced media on the client display apparatus.

56. The apparatus of claim 55 wherein said means for receiving said display condition information comprises means for receiving at least one of:
a serial number associated with the interactive sequenced media;
a name associated with the interactive sequenced media;
a length of the interactive sequenced media;
a number of frames per second associated with the interactive sequenced media;
a display area size of a media viewer used on the client display apparatus to display the interactive sequenced media;
a video compression/decompression algorithm (codec) associated with the interactive sequenced media; and
an audio compression/decompression algorithm (codec) associated with audio content in the interactive sequenced media; and
a category associated with the interactive sequenced media; and
information indicating that the user has viewed a first portion of the interactive sequenced media.

57. The apparatus of claim 53 wherein said means for receiving said billing message further comprises means for receiving a location and a name of a script stored on the billing server, said script being operable to read and interpret said billing message.

58. The apparatus of claim 53 further comprising means for storing said dynamic object identifier in a billing entry table in a database.

59. The apparatus of claim 58 wherein said means for associating said billing entry with a sponsor account comprises means for reading said dynamic object identifier stored in said billing entry table and means for locating a sponsor record having a corresponding dynamic object identifier, said sponsor record being stored in a sponsor table in the database.

60. The apparatus of claim 59 wherein said means for locating further comprises means for reading a sponsor name field in said sponsor record and means for causing a charge entry to be added to a sponsor account table stored in the database.

61. The apparatus of claim 59 wherein said means for causing said charge entry to be added comprises means for causing a charge entry to be added to said sponsor account table, said charge entry including display condition information associated with displaying the interactive sequenced media on the client display apparatus.

62. The apparatus of claim 61 further comprising means for reading said sponsor account table and causing a bill to be produced for sending to said sponsor.

63. A billing server apparatus for billing a sponsor of a dynamic object in interactive sequenced media, the apparatus comprising a processor circuit operably configured to:
receive a billing message at a billing server, said billing message representing user selection of an object link that follows the dynamic object displayed in interactive sequenced media on a client display apparatus, said billing message including a dynamic object identifier identifying the dynamic object; and
associate a billing entry with a sponsor account associated with said dynamic object identifier to make a charge to said sponsor account as a result of said user selecting the object link.

64. The apparatus of claim 63 wherein said billing message comprises at least one of:
a time duration for which the dynamic object was displayed;
a number of display pixels occupied by the dynamic object when displayed; and
information identifying an additional action performed in response to said selecting.

65. The apparatus of claim 63 wherein said billing message further comprises display condition information associated with displaying the interactive sequenced media on the client display apparatus.

66. The apparatus of claim 65 wherein said display condition information comprises at least one of:
a serial number associated with the interactive sequenced media;
a name associated with the interactive sequenced media;
a length of the interactive sequenced media;
a number of frames per second associated with the interactive sequenced media;
a display area size of a media viewer used on the client display apparatus to display the interactive sequenced media;
a video compression/decompression algorithm (codec) associated with the interactive sequenced media; and
an audio compression/decompression algorithm (codec) associated with audio content in the interactive sequenced media; and
a category associated with the interactive sequenced media; and
information indicating that the user has viewed a first portion of the interactive sequenced media.

67. The apparatus of claim 63 wherein said billing message further comprises a location and a name of a script stored on the billing server apparatus, said script being operable to read and interpret said billing message.

68. The apparatus of claim 63 wherein said processor circuit is operably configured to provide database functions and wherein said processor circuit is operably configured to store said dynamic object identifier in a billing entry table in said database.

69. The apparatus of claim 68 wherein said processor circuit is operably configured to read said dynamic object identifier stored in said billing entry table to locate a sponsor record having a corresponding dynamic object identifier, said sponsor record being stored in a sponsor table in said database.

70. The apparatus of claim 69 wherein said processor circuit is operably configured to read a sponsor name field in said sponsor record and to cause a charge entry to be added to a sponsor account table stored in said database.

71. The apparatus of claim 69 wherein said processor circuit is operably configured to cause a charge entry to be added to said sponsor account table, said charge entry including display condition information associated with displaying the interactive sequenced media on the client display apparatus.

72. The apparatus of claim 71 wherein said processor circuit is operably configured to read said sponsor account table and to cause a bill to be produced for sending to said sponsor.

73. A system for displaying interactive sequenced media, the system comprising:
a client display apparatus; and
a billing server;
said client display apparatus and said billing server being in communication with a computer network;
said client display apparatus comprising a processor circuit operably configured to:
cause at least one dynamic object in the interactive sequenced media to be displayed, said dynamic object having an associated object link that follows said dynamic object; and
cause a billing message to be transmitted over said computer network to said billing server in response to a user of the client display apparatus selecting said object link, said billing message including a dynamic object identifier identifying the dynamic object;
said billing server comprising a processor circuit, said processor circuit being operably configured to receive said billing message from said client display apparatus and associate a billing entry with a sponsor account associated with said dynamic object identifier to make a charge to said sponsor account as a result of said user selecting the object link.
